(19) United States
(12) Patent Application Publication
(10) Pub. No.: US 2026/0319976 A1
(43) Pub. Date: Oct. 15, 2026

(54) Adaptive Parallel Series Agentic AI Computing Machine and Devices

(71) Applicant: Jonathan Glickman, Holliston, MA (US)

(72) Inventor: Jonathan Glickman, Holliston, MA (US)

(21) Appl. No.: 19/644,793

(22) Filed: Apr. 10, 2026

Related U.S. Application Data
(60) Provisional application No. 63/787,581, filed on Apr. 11, 2025.

(51) Int. Cl. G06F 13/12

(52) U.S. Cl. CPC G06F 13/126; G06F 2213/40

(57) ABSTRACT

A computer system including a first node having an I/O controller hub including a main communication chipset, a common bus, and one or more adaptable parallel-series agentic artificial intelligence (AI) nodes coupled to said first node by said common bus. Each of the one or more adaptable parallel-series agentic AI nodes include a memory operative to host an adaptable parallel-series operating system, and at least one central processing unit (CPU) coupled to said memory, the respective one of the one or more adaptable parallel-series agentic AI nodes is configured without an adaptable parallel-series chipset, wherein at least one of the one of more of adaptable agentic AI parallel-series nodes functions as a processing unit of the first node, and at least one of the one or more adaptable parallel-series agentic AI nodes is coupled to and shares the I/O controller hub.

### CROSS-REFERENCE TO RELATED APPLICATION

This application claims the benefit of U.S. Provisional Application No. 63/787,581, filed Apr. 11, 2025, the contents of which are incorporated by reference herein.

### BACKGROUND

Computer systems typically include a combination of hardware and software components, application programs, operating systems, processors, buses, memories, input/output devices, and so on. As advances in semiconductor processing and computer architecture push the performance of the computer higher and higher, more sophisticated hardware and software arrangements have evolved to take advantage of the technology, resulting in computer systems today that are much more powerful than just a few years ago.

One of the areas in which progress has been made is managing computer resources in a distributed computing system. Conventionally, distributed computing environments often require complex management schemes and systems for distributing the tasks that constitute the complete job to be performed. The complex management system is responsible for collating the processing results. Such a distributed computing environment requires a linked, dedicated, cluster of computers for performing such processing. The computer cluster usually is a linked group of conventional motherboards containing local disk controllers via a network device. Thus, the network speed is limited by the performance of communication medium, including the network device.

Computer designs have been based on grouping devices that have had similar operational speeds together, so mechanical hard drives which typically had millisecond response rates were grouped together separately from CPUs and memory that resided on a motherboard which had nanosecond response rates. Traditionally disk access has been more of a bottleneck problem than a network switch. Thus, a network switch able to distribute processing across various computer systems has not been an issue. Now, however, solid state drivers (SSD) have been developed which operate at memory speeds and can even exceed speeds at which some current bus controllers can manage. No longer are hard drives a bottleneck of the system, rather they soon will operate at the same speeds of the typical CPU, memory, or any of the processor local bus architectures (Intel®, AMD®, Server ARM® chips, RISC®, IBM® . . . ) which used to be reserved for communicating between the memory and CPU.

### SUMMARY

In one aspect, a computer system includes a first node having an I/O controller hub including a main communication chipset, a common bus, and one or more adaptable parallel-series agentic artificial intelligence (AI) nodes coupled to said first node by said common bus, each of the one or more adaptable parallel-series agentic AI nodes including a memory operative to host an adaptable parallel-series operating system, and at least one central processing unit (CPU) coupled to said memory, the respective one of the one or more adaptable parallel-series agentic AI nodes is configured without an adaptable parallel-series chipset. At least one of the one of more of adaptable agentic AI parallel-series nodes functions as a processing unit of the first node, and at least one of the one or more adaptable parallel-series agentic AI nodes is coupled to and shares the I/O controller hub.

In some implementations, the I/O controller hub includes a main network device, and at least one of the one or more adaptable parallel-series agentic AI nodes is coupled to and shares the main network device and is capable of dynamically generating code from multi-agent AI foundational models.

In some implementations, at least one of the one or more adaptable parallel-series agentic AI nodes is directly coupled to and shares the main network device.

In some implementations, the common bus physically and electrically connects one of the one or more adaptable parallel-series agentic AI nodes to another of the one or more adaptable parallel-series agentic AI nodes.

In some implementations, the common bus couples the one or more adaptable parallel-series agentic AI nodes to the first node.

In some implementations, each of the one or more adaptable parallel-series agentic AI nodes includes at least one solid state memory drive.

In some implementations, each of the one or more adaptable parallel-series agentic AI nodes includes a solid-state drive (SSD).

In some implementations, one of the one or more adaptable parallel-series agentic AI nodes hosts a first adaptable parallel-series operating system and another of the one or more adaptable parallel-series agentic AI nodes hosts a second adaptable parallel-series operating system that is different from said first adaptable parallel-series operating system.

In some implementations, one of the one or more adaptable parallel-series agentic AI nodes and another of the one or more adaptable parallel-series agentic AI nodes host the same adaptable parallel-series operating system.

In some implementations, one of the one or more adaptable parallel-series agentic AI nodes operates as a master node and another of the one or more adaptable parallel-series agentic AI nodes operates as a slave node.

In some implementations, the common bus includes at least one of a Peripheral Component Interconnect Express (PCIe) bus and a switched fiber fabric.

In some implementations, the common bus serially connects one of the one or more adaptable parallel-series agentic AI nodes to another one of the one or more adaptable parallel-series agentic AI nodes.

In some implementations, each of the one or more adaptable parallel-series agentic AI nodes includes a first disk controller that is accessible by the common bus.

In some implementations, each of the one or more adaptable parallel-series agentic AI nodes includes a second disk controller configured to connect to an external storage device.

In some implementations, the first node is absent a processing unit and operates as network HUB.

In some implementations, the computer system is a virtualized computer system.

In some implementations, a specific function is assigned to each of the one or more adaptable parallel-series agentic AI nodes, and upon request, the respective one of the one or more adaptable parallel-series agentic AI nodes executes the assigned specific function.

In another aspect, a computer device includes a first node an I/O controller hub, a stack of one or more adaptable parallel-series devices, each of the adaptable parallel-series devices being coupled to the first node, each of the one or more adaptable parallel-series devices being operative to host an adaptable parallel-series operating system and each of the one or more adaptable parallel-series devices being connected to a memory, and a common bus connecting the one or more adaptable parallel-series devices to the first node, wherein at least one of the one or more of said adaptable parallel-series devices functions as a processing unit for the first node, and the at least one of the one or more adaptable parallel-series devices is coupled to and shares said I/O controller hub.

In some implementations, the I/O controller hub includes a main network device, and at least one of the adaptable parallel-series devices is coupled to and shares the main network device.

In some implementations, at least one of the adaptable parallel-series devices is coupled to and shares the main network device, and is absent an external I/O circuit.

While specific implementations have been described for specific aspects, any of the above-noted implementations and features of the above aspects can be combined with any of the other aspects. For example, features and/or implementations described with reference to the first aspect can be used with second aspect, and vice versa, etc. In addition, any combination of the above-noted aspects is also within the scope of this disclosure.

The implementations described herein can include one or more of the following advantages.

Implementations can improve code generation by dynamically generating code and statistical models. By augmenting accelerated offloading processors with agentic AI dynamic code generation and loading the code into components controllers, implementations can be dynamically reconfigured in a supervised or unsupervised manner. As a result, implementations, can exhibit more autonomous decision-making that realizes goal-directed behavior and adaptability.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

Non-limiting and non-exhaustive examples are described with reference to the following figures.

FIG. 1 is an elevational view of an Adaptive Computing Machine workstation implementing the present disclosure's Adaptable parallel-series nodes showing a compact structure thereof.

FIG. 2 is an elevational view of Datacenter HPC version of an Adaptive Computing Machine implementing the present disclosure's Adaptable parallel nodes showing a compact structure thereof.

FIG. 3 is a block diagram of an Adaptive Computing Machine exemplary detailing the flexibility of parallel configurations.

FIG. 4 is a block diagram of another an Adaptive Computing Machine exemplary detailing the flexibility of Series-Parallel configurations.

FIG. 5 is a block diagrams of the other an Adaptive Computing Machine exemplary detailing the flexibility of Series-Series configurations.

FIG. 6 is an schematic block diagram according to the Adaptive Computing Machine SoC (System on a Chip) present disclosure.

FIG. 7 is an electrical schematic block diagram according to the Adaptive Computing Machine present disclosure of a peripheral hub board and an Adaptable parallel-series Agentic AI boards/devices showing the main components and their configurations.

FIG. 8 this is a gaming or PC workstation version of a Peripheral Hub board whether on a separate board or integrated into a traditional motherboard design.

FIG. 9 is Adaptable parallel-series GPU version of the Sibling Technology that can range from a gaming GPU all the way up to a HPC machine.

FIG. 10 is Adaptable parallel-series DPU version of the Sibling Technology that can range from a workstation version of a DPU all the way up to a HPC.

FIG. 11 is Adaptable parallel-series Storage Unit version of the Sibling Technology that can range from a workstation version of a DPU all the way up to a HPC.

FIG. 12 is Adaptable parallel-series targeted Application version of the Sibling Technology that can range from a workstation version of a DPU all the way up to a HPC.

Like reference numbers represent corresponding parts throughout.

### DETAILED DESCRIPTION

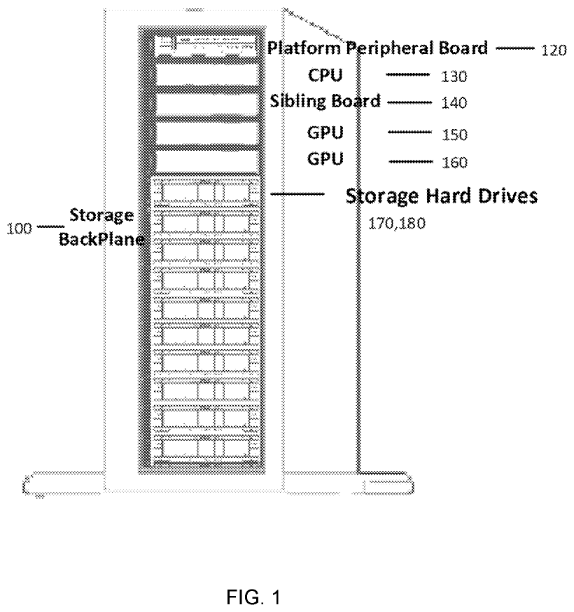

FIG. 1 is an elevational view of an Adaptive Computing Machine workstation implementing Adaptable parallel-series technology showing an example of the structure thereof. Referring to FIG. 1. An Adaptive Computing Machine workstation 1 implementing the present disclosure's Adaptable parallel-series Agentic AI technology is depicted. U.S. Pat. No.9,135,203, incorporated herein by reference in its entirety, referred to a Series connection to be synonymous with the popular terms such as streaming, pipelining, and sequential of a direct physical node to node connection between the memories of the two accelerated components. Each component is accelerated by having access to memory preferably its own Memory, CPU along with Application Libraries contained in its controller. The term “Sibling” was used which predated the currently commonly used term for an Adaptable parallel-series cluster node be it a server, board, or IC therefore from now on will be referred to as a “Node”. In a component or an IC or even portion of an IC which can be considered an Adaptable parallel-series cluster node is one form of a family of devices. FIG. 1 can comprise of a mix of Adaptable parallel-series cluster node and regular nodes. It is not mandatory that every node in the system by an Adaptable parallel-series cluster node rather that there has to be a minimum number of nodes for a series connection to occur. Other industry names for on the component level are Adaptable parallel-series cluster technology are Velocity Architecture, GPUDirect, Peer-to-Peer (P2P) Memory Access to name a few and (Compute Express Link) CXL, (Universal Chiplet Interconnect Express) UCIe on the IC level and the list goes on and on all can be attributed to Adaptable parallel-series cluster technology at their core. Such boards, components and ICs, therefore the term Adaptable parallel-series devices are synonymous with a member of a family referred to as Adaptable Parallel-Series Cluster. A node can be a computerized component like NVMe SSDs, a computerized GPU, and SOC of various degrees or even network devices such as DPU, switch or router. On the IC level it could be as rudimentary as CPU such as a MCM or Chiplet technology similar to the EPYC chip that has Chiplets CPU nodes with various numbers of CPU Cores connected to a Hub Chiplet I/O Die that handles peripheral communication and Infinity Fabric bus activities as well as various forms of Adaptable Parallel-Series L2, L3 cache and even 3D V-Cache (3 dimensional chip cache) and includes NPU, and ASICs, FPGA or associated accelerated technologies. A component can have its controller act like a Netezza S-blade capable of parallel-series processing acts as an Adaptable Parallel-Series technology node (board, component and or IC or portion thereof) which is a testament to its modularity. Now that the Adaptable Parallel-Series technology is enhanced by the addition of NPU (Neural Processing Units) or similar technologies and other offloading processors it is fully capable of self-contained AI processing and code generation to load code dynamically. The Adaptable Parallel-Series technologies has many other SOC variations targeted at various aspects of computing like networking MPU (Matching Processing Unit) which allows a Adaptable Parallel-Series board (node) to act as a DPU and function as a router in Software Defined Networks to a NPU included with CPU and memory FPGA to dynamically load code into the controller to prefetch data including metadata and process it internally. Agentic AI that employs Multi-agent Multi-staged technology can be considered a Adaptable Parallel-Series node or device capable of doing dynamical code loading parallel-series processing if NVMe SSDs, GPUs, Network devices like DPUs, Switches and routers including Software Defined Networks can be augmented with FPGAs, ASICs, NPUs, LPUs (Language Processing Units), TPU tensor deep learning performance in neural network processing especially in Foundation Model production, IPU (Infrastructure Processing Unit introduced by Intel), APU (Application Processing Unit usually coupled GPU+CPU). By augmenting these accelerated offloading processors with Agentic AI dynamic code generation and further more loading it into components controllers the Adaptable Parallel-Series machine becomes an Agentic AI embedded Adaptable Parallel-Series Machine that can dynamically reconfigure itself in a supervised or unsupervised manner with the assist of deep learning of its metadata generated from job run, performance, changes in the operating environment. Agentic AI systems exhibit autonomous decision-making that realizes goal-directed behavior and adaptability. Agentic AI systems can perceive, learn and process data and the code required to best fit while constantly adapting to the total environment with supervised or unsupervised human like capabilities. Agentic AI can plan, designate and orchestrate tasks as well as review them to ensure parts of the workflow plan are not overlooked in an autonomous manner while collaborating with other agents connected to various foundational models through NLP (natural language processing) that can be textual, verbal or though messaging. As Manufacturers were starting to realize that affordable SSDs were opening new forms of computer architecture around the year 2016 due to the fact that now all of the components on the board now act at the relative same speed. This new SSD technology opened up a whole opportunity for a new computer architecture that allows for components on the board to interact with each other directly without requiring the CPU and system memory to be involved except for possible buffering by having their own CPU and memory that includes an embedded application. components were able to prefetch data including metadata, process it with embedded application code with their controllers and memory and pass the results directly to the memory of the next component over the bus. The use of sophisticated scheduler that employs augmented in conjunction with the use of a database schemas similar to Common Information Management (CIM) database design or Splunk to process logs can be combined with artificial intelligence (AI) to maximize the job stream and dynamically load application code when needed to be used to prefetch data into controllers and memory of these accelerated Adaptable Parallel-Series components. The term pipeline was traditionally used in reference to CPU to process carry look-ahead steps that didn't have dependent steps that needed to be processed first. Since there will be steps in the job stream that don't have dependent steps code can be dynamically processed and the results can be ready similar to how CPU pipelines work. Therefore the term Adaptable parallel-series cluster will be used to mean two accelerated components whose controllers are augmented by memory and CPU and accelerated by embedded application code to have a direct physical connection between each of their memories over a physical bus that bypasses the necessity of requiring system CPU involvement and are capable of parallel processing on multiple lanes of that physical connection between the nodes or SerDes technology that manages data striping across multiple lanes. The terminology used in U.S. Pat. No. 9,135,203, incorporated herein by reference in its entirety, was called Adaptable Parallel-Series technology is now referred to as Adaptable parallel-series technology. In its modern form a Adaptable Parallel-Series board, component or node can take many forms of devices from a single chip to a datacenter cluster. SerDes, or serializer/deserializer is a core technology that uses lanes that consist of pairs of wire pairs to reduce crosstalk uses in very high-speed multi lane communications that is used to convert parallel communication to serialized for fast data transfers in multiple bus transfer technologies from board to the IC. Adaptable parallel-series technology in its IC form that has a Hub chip in the center and Parallel-Series Bus capable of using a more traditional parallel-series I/O serializer-deserializer (SERDES or SerDes) logic resides on the Hub I/O die capable of DDR memory controllers, smart cache coherency, across PCIe SerDes managed lanes as well as the newer UCIe-like links to connect “smart” dies on a single substrate InFO-oS (Integrated Fan-Out on Substrate) Sea-of-Wires producing much better performance than traditional SerDes based technologies. The IC includes disk controllers and (Compute Express Link) CXL connectivity, Global Memory Interface (GMI), secure memory encryption, plus Server Controller PCH (Platform Controller Hub) Hub functionality that manages peripherals and system management similar to the like the EPYC chip and its Infinity Fabric bus. At its core there can reside a Hub board in IC form but not mandatory to the functionality of the IC. U.S. Pat. No. 9,135,203, incorporated herein by reference in its entirety, describes scaling the flexible parallel-series architecture from the blade to the component to the IC by using accelerated computerized components to prefetch data and metadata to process data inside component. Splitting of the motherboard to alleviate the heating issues that hardware acceleration is known to produce. Adaptable parallel-series technology in its board form put the PCH chipsets on a separate hub board lowered the impedance of the main board so that its accelerated hardware could be air cooled. This separate hub board or split motherboard is described in U.S. Pat. No. 9,135,203, incorporated herein by reference in its entirety. Parallel-Series technology was first demonstrated by the Microsoft Xbox series X design and then migrated in IC server chips. The Xbox from its inception was plagued by overheating problems so much that eventually a redline warning was put on the device to let the user know that the system was overheating to the point of meltdown which the split motherboard lowered impedance of the main board and solved the overheating problems. To extend the lowering of impedance the physical hardware motherboard can be virtualized meaning any component that is prone to overheating can have a separate board in the attempt to minimize the issue. By virtualizing the actual board allowing for each major component to respectively have its own board can allow for a support system to attach the components to thus giving the appearance of a singular board but all the benefits of lowering the impendence of the overall system. Another aspect of the cooling design was using the parallel-series architecture to prefetch and process data especially metadata that optimizes exactly what data is needed inside the SSD and transfer it via DMA (Direct Memory Access) or RDMA (Remote Direct Memory Access) to the memory of the GPU to its compute kernel with little processing of the CPU or the system memory. Not only did this “velocity architecture” boast of a three times performance improvement over the traditional Von Neumann architecture with the same accelerated components but also allows for the system to run cooler. Kirchhoff's first law states that the sum of all the currents that flow into a node or at a point must equal the sum flowing out for a net of zero. Similarly Kirchhoff's second law that deals with voltages in a loop states that voltage differences around a closed loop is also zero. However Kirchhoff's laws say nothing about the placement of these circuit nodes or loops in reference to the board or boards they reside on. In other words Kirchhoff's law apply exactly the same as if total number of components reside on a singular board or if each component has its own board exclusively the entire circuit is still the same. Therefore any component on a traditional motherboard now can have its own board if its determined that the impedance is high enough that it could overheat. The significance of this is in computer and other hardware systems is that the overall heat dissipated in the system can be alleviated by taking the major components in the system that have the tendency to overheat and placing them on their own board with a an optional heat sync to dramatically lower the heat dissipation in the system without changing the integrity of the circuit. This technology can access Central Processing Units (CPUs), high speed volatile memories, various forms Solid State Drives (SSDs), SRAM, VRAM, DRAM, Memristors like Resistive random-access memory RRAM (and similar technologies such as 3D XPoint, VRAM, NVRAM etc.), Application-Specific Integrated Circuit (ASIC), Field Programmable Gate Array (FPGA), Graphics Processing Unit (GPU) or other Very Large Scale Integrated circuit (VLSI), Digital Signal Processor (DSP), System on a Chip (SoC), Configurable System on Chip (CSoC) and Optic Fiber (also referred to as Fibre) , Silicon Photonics, Network Fabrics and devices, AI, Neural Processors Units (NPU) and even Quantum Computing type accelerator devices QPU (Quantum Processing Unit) which excels in probabilistic possibilities which can grow to unwieldy datasets sizes conventional computers can't handle. Potential offloading processors in combinations thereof but can dynamically embed application engines into intelligent disk, memory or network controllers that can also act as a host or typical blade to reduce server sprawl in an energy and cost efficient manner by performing dynamic parallel-series processing. As Quantum Computing becomes more viable this technology can be utilized for error checking. However GPU technology is the backbone behind the AI revolution that has made LLMs and other associated foundational model models possible due the dramatic performance boost of not only having components interfacing directly with each other and utilizing compression and decompression along with encryption and hashing and embedded AI technologies on the board but across the network of any type.

In the FIG. 1 depicted Workstation modern GPUs can be specific such as GPGPU and TPU or combinations of core types such as CUDA or OpenCL combined with Tensor and Ray Tracing cores in one unit. TPUs designed for tensor operations and machine learning involving large-scale neural networks that have lower precision number formats that paved the way for NPU. The present Adaptive Computing Machine disclosure provides for a flexible configuration of an internal array of Adaptable parallel-series nodes arranged in board, chips or cores that can also act as sophisticated disk controllers that access to storage through a high speed common bus fabric but is not limited by the type of bus fabrics used and can be extended to emerging technologies (too numerous to mention like neuromorphic brain-like computer chips, quantum computing, Memristors and AI processors, GPUs, TPUs, APUs, LPU and so on) and even technologies that haven't even been conceived yet. Adaptable parallel-series Agentic Ai technology that contain more than one node can have the option of being further sub-partitioned into Adaptable parallel-series cores so each of the cores can function as a processing unit or as a disk controller through the host operating system. The present Adaptive Computing Machine disclosure can employ several fabric technologies for the entire system, including the common bus and the disk controller bus or it can employ several different type of HBA (Host Bus Adapters), TBA (Target Bus Adapters) and TCA (Target Chanel Adapters) technologies and Fabrics like RoCE Express and its associated technologies such as InfiniBand and its variants, iWARP, RoCE (RDMA over converged Ethernet), Ultra Ethernet Transport (UET), Compute Express Link (CXL), and proprietary Fabrics NVLink Intel Omni-Path, GigaIO FabreX, to name a few, as well as Unified Fabrics such as GPUDirect, NVMe over Fabrics (NVMe-oF) and the capabilities of PCIe version 6 and beyond depending what are more conveniently available. Adaptable parallel-series DPU cards and SOCs can employ any number of Coprocessors such as AI, GPU, TPU, LPU, APU (Associative Processing Unit), NPU (neural processing unit), MPU (Matching Processing Units), Neuromorphic Chip that mimic brain neurons, to QPU (Quantum Processing Units) and Math and Vector processors that employ smaller number formats with fewer bits and reduced mantissa geared to improve the inference performance whose resources can also be configured to be shared between the different modes of operation amongst the Adaptable parallel-series nodes. Traditionally AI Model training used 32-bit floating point numbers whereas today popular floating point formats such as 4 bit FP 4 8-bit FP 8 or 16-bit such as Bfloat 16 (Brain Float 16), FP16, and FP32 formats, as well as FP 8 forward passes and back passes activations and are often combined in a “mixed-precision” providing accurate calculations and performance required for each specific stage. While inference neural nets usage benefits from smaller numbers that represents weighs 8-bit integer (whole) numbers and even FP4. Google Brain proposed the use of called BFloat16 or Brain Float 16 number format geared for or AI/deep learning applications. This new Brain Float format reduces energy consumption needed multiplying tensors together attributed to reducing the precision of the numbers in AI processing while offering a tradeoff to traditional AI training and inference. The Adaptable parallel-series technology can also be used to upgrade competing technologies into Adaptive Computing Machines by integrating Adaptable parallel-series nodes into an existing system. While GPGPU are adapted from graphics processing units to perform general-purpose computations that include AI workloads. Tensor cores support several precision levels FP4, FP6, FP8, FP16, BF16, TF32, FP64, and integer formats (INT8, INT4) (and even FP64 in newer generations), while TPUs are typically optimized for lower precision. This dynamic capability of producing, testing and then loading code orchestrated through a scheduler would dramatically increase the flexibility and performance of the Adaptable parallel-series cluster board, components and ICs that is currently on the market which all the application and API code is hard coded into ASICS portions of the chips limiting the capabilities of the system. Employing hashing with a zone map and metadata will allow the system to know where all the data is similar to how zone maps were used in Netezza can be localized to SSD Storage, clustered GPUs such NVLink or system wide. Imagine gaming systems that were fluid enough to adapt game but have the ability to adapt to the gaming environment of each player. AI machines could be dynamically tweaked to accommodate complex financial models for predictive analysis by harnessing machine learning algorithms and dynamically loading them into or accessed by controllers for prefetching data and then making more acute predictions than hardcoded libraries. Thus the Adaptable parallel-series cluster not only can change its configuration by harnessing a scheduler to dynamically load application and API to fit the job stream but has the ability to actually dynamically produce code and statistical models and compile, unit test them and then load them into the appropriate component at the appropriate time.

Workstation depicted in FIG. 1 utilized development frameworks for building local and cloud AI Multi-Agent Foundational Model Systems have appeared that call multiple AI foundational models and communicate between the different agents refine and produce code, graphics, and sound and storytelling tasks. One popular one is Microsoft AutoGen which uses AI Multi-Agent Systems to produce content. Similar such AI development frameworks can be loaded into controllers or produce code to be dynamically loaded to be used as application compute kernel libraries. These Multi-Agent Agentic AI systems can be Multi-Staged systems that have complex task orchestration, analysis, hill climbing review of generated code from each agent to produce an output. This technology when married with Adaptable parallel-series clusters to be able to analyze it environment using metadata to produce code, compile it, review it quality, completeness, and functionally and then load it dynamically into controllers to optimize performance and functionality. However those that work with LLMs in complex natural language processing (NLP) tasks have noticed that a single stage approach no matter how complex the review process tends to forget portions of the overall task. The AI compute environment is exploding with new technologies such as ChatGPT o1 reasoning model, and Inception Labs dLLM (diffusion based LLM models) that claims to give speed advantage by supporting advanced reasoning capabilities by providing built-in error correction mechanisms where it uses machine and deep learning to iteratively filter noise and unwanted data from a target data distribution. Functions it calls can be omitted, paragraphs outlined in the tasks list such as reviewing large volumes of legal documents against a legal brief or patent can go missing. That is why a Multi-Staged Multi-Agent Agentic AI systems approach that can mix local LLM or Foundation Models with cloud models as well as MCP Servers is completely feasible and warranted unless companies don't want sensitive code loaded to public clouds thus only local models would be appropriate. Hugging Face and a myriad of cloud sites allow for original and distilled models targeted for various applications are readily accessible that can be used to dynamically generate code, compile it, review it, analysis its performance and results in multiple stages from the various outputs. There could be multiple types of agents that correspond to multiple appropriate foundational modal models to produce viable content to be dynamically loaded into the controllers or utilized by the Adaptable parallel-series technology.

These AI Multi-Agent Systems will be employ various techniques such as Reflection, ruminate, Panel of Experts (POE), and hill-climbing optimization but is not limited to can also employ ADAS (Automatic Discovery of Agential Systems), active learning, adaptive learning, attention mechanism, bias mitigation, catch-all error handling, chain of thought reasoning, collaborative filtering, collaborative model training, comprehension monitoring, Context-aware responses, contextualization, contextual embedding, curriculum learning, data augmentation, data privacy, data sparsity, dynamic prompt generation, error mitigation, exemplars, explainability, feedback mechanism, feedback score, fine-grained analysis, fine-tuning, fine-tuning dataset, generative model, gradient descent, hill-climbing optimization, human-in-the-loop, inference, institutional knowledge, interactive learning, interpretability, interface design, iterative refinement, knowledge distillation, knowledge graph, knowledge retention, language generation quality, language model benchmarking, language understanding, language variability, latent variables, loss function, meta-learning, model architecture, model ensemble, model robustness, multi-modality, natural language processing (NLP), one-shot learning, out-of-context responses, overfitting, paraphrasing ability, performance metrics, pre-trained model, prompt engineering, prompt response ratio, prompt tuning, query expansion, regression analysis, reinforcement learning, scalability, semantic coherence, semantic model, semantic search, semantic similarity, self-supervised learning, stochastic sampling, text retrieval, tokenization, tokenizer, training dataset, training epoch, transfer learning, underfitting, unsupervised learning, user feedback loop, user intent recognition, user-centric design, zero-shot learning.

Workstation depicted in FIG. 1 features Multi-Agent Foundational Model Agentic AI systems can automate the generation of lists of high-level tasks that are comprehensive enough to refine a hierarchy of tasks and subtasks and orchestrate a workflow to carry them out systematically and can be local to the system or board. These workflows similar to DAGs utilized by scheduling systems such as Airflow can be used to identify and mange dependencies between the tasks of the workflows. Systems such as Airflow serialize these workflow DAGs in a database and have their own web front end to interface with the Admin and development users. The AI Multi-Agent Agentic AI RAG systems can be integrated with external programing frameworks such like the ones from Apache to produce DAGs that have tasks that produce, QA, and other Software Development Life Cycle (SDLC) tasks consisting of structured phases—planning, analysis, design, development, testing, deployment, and maintenance and then dynamically load dynamically generated application code into the component controller to be implanted as an Application Compute Kernel. The Airflow system can also implement Apache Spark and other Apache frameworks like Kafka, Kubernetes and others in the Apache suite to enhance the dynamic code generation to be loaded inside the controllers or as an end product while interfacing with sophisticated scheduler that employs a database similar to Common Information Management (CIM) database design with Splunk, Rack Managers with database capabilities that interface with (Intelligent Platform Management Interface (IPMI), Baseboard Management Controller (BMC), out-of-band management (OOB), lights-out management or (LOM), Redfish enhanced schedulers. Rack Managers can even have a BMC SOC that has their own CPU and memory in the controllers and SSDs of various kinds such as NVMe and a NPU to analysis metadata. It is common for TOR or Utilizing the Apache frameworks in unison with the various schedulers mentioned or the ones included in tools such as Airflow can manage the various dynamically produced codes to be employed in the controllers Adaptable parallel-series components controllers as Application compute kernels or as general applications. These tasks can also interface with Vector databases that can hold static information for databases, application frameworks and APIs along with other content. One usage of a Vector could be for holding pertinent textual information of dimension tables of a star schema or static tables of an operational 3NF data warehouse or Data Vault lookup or satellite tables for the generation of SQL commends generated from NLP (Natural Language Processing) interfacing with LLMS. Database kernels can have portions inside the components accelerated controllers such as SSD and GPUs to filter data from NLP (Natural Language Processing) tasks much in the same way that Netezza did which is where this technology has its roots. Databases are currently utilizing vector column datatypes that all LLMs to loaded into the database and used to process NLP and textual portions of alphanumeric character datatype information and then tokenize the information and store it in a vector column in the table. This would allow for SQL vector searches to be combined with SQL statements or as another query option to search the table against a set of criteria that can even be NLP based. This would allow for textual or vocal NLP (Natural Language Processing) to be utilized that could be translated into SQL or other database languages such as graph, NoSQL, Object, Document, Hierarchical, Network in a distributed manner. The application of Adaptable parallel-series cluster technology that plays any dynamic, scheduled or specifically assigned roles in a single board, rack or HPC machine evolved in deep learning training a Large Language Model (LLM) can involve several key steps. The Data Collection is generally considered the first step of producing a LLM from scratch. The application of Adaptable parallel-series cluster technology that plays any dynamic, scheduled or specifically assigned roles in a single board, rack or HPC machine evolved in deep learning training a LLM can involve several key steps. The Data Collection is generally considered the first step of producing a LLM from scratch. However as the Retrieval-Augmented Generation (RAG) technology evolves the fine line of producing a new Foundational Model and utilizing technologies such as Vector Databases is blurring. Continual learning updates models incrementally without full retraining while preserving older knowledge employing technologies like Elastic Weight Consolidation (EWC). There are public sources of data to use that are trained on diverse public data sources to ensure proper tokenizing by applying standard data warehousing data quality techniques. These public data sources range from Common Crawl, RefinedWeb, Pile, FineWeb, OpenMathInstruct-1 and C4 a Colossal Clean Crawled Corpus that can be further augmented for better results. The next phase usually employs some form of Model Configuration that configures the transformer neural network, defining parameters such as the number of layers, attention heads, and hyperparameters. The some form of Pre-training that prepared text data into the model, with the goal of being able to predict subsequent words in sequences which is repeated hundreds of times for performance optimizations. Supervised Learning (Instruction Tuning) that trains the model to respond to specific instructions and requests to enhance the quality of its interactive abilities. Fine-tuning is usually performed to customize and improve accuracy for the pre-trained model for specific tasks or domains for particular applications that utilizes parameter-efficient fine-tuning algorithms (LoRA or adapters). Reinforcement Learning then encourages desirable behaviors and discourages harmful language in further refining the model's output to which finally the model is evaluated or checked for quality. These techniques can be embedded in the controller of the Adaptable parallel-series cluster during the training phase to assist the generation of Foundational models or can have the resulting code that the use of inference and or enhancement such as the use of vector database and similar technologies from these Foundational models scheduled to be embedded in the application compute kernels dramatically improve the performance. Any phase of the training, inference or enhancement of Foundational models can be have the code including neural nets and various other machine and deep learning algorithms embedded in the application compute kernels. Libraries like llama.cpp offer a C-style interface to LLM models or GGUF format for direct deep learning algorithms that can perform Natural Language Processing (NLP) tasks communication that can interface with scheduling and job stream metadata during inference generate everything from code to human-like responses with the user interface be it verbal, textual or GUI. Once the Foundational models such as a LLM interact with the scheduling systems the system can learn about deficiencies and dynamically generate, test and load into Adaptable parallel-series components controllers or other sections to enhance the performance of the job stream of tasks. Not only can the system autonomously improve performance but can enhance its code and dynamic placement of code to automatically adapt to the job stream from the metadata it collects from previous runs. Currently there are database companies such as Oracle that autonomously improve performance of databases that utilize a rule-based autonomous database cloud service framework on mainly the database level by sensing poorly performing SQL statements or lack of resources that employ elasticity to solve the problem but don't dynamically adjust the configuration of the components in their boards dynamically adapt to the job stream. During certain times in the job stream certain algorithms can be loaded into the Adaptable parallel-series cluster components to prefetch data for instance in the components controller and then pass the results in series to another component that was configure with dynamically fitted algorithms that not only avoids the Von Neumann bottleneck but can employ encryption, compression and decompression and hashing to act like a dynamically configurable Netezza S-blade in the controller that not only uses metadata it stores and employs in a zone map but the code and its refinements to optimize the job stream.

In FIG. 1 Workstation typically an Adaptable parallel-series Cluster board (Sibling Board) would be provisioned as a host data processing board with its components having embedded application memory, network and storage controller, however due to its adaptable nature of dynamically loading application and API code into the controller or auxiliaries it can be designated solely as a dedicated IN-memory, network or storage controller or the combination thereof to take advantage of its parallel and series (Hadoop pipeline) processing. The flexibility of Adaptable parallel-series Cluster board (Sibling Board) is that it can be provisioned to implement distinct designated roles in the system or can be employed to play numerous roles as a host and embedded controller. The Adaptive Computing Machine that employs Adaptable parallel-series Cluster board (Sibling Board) can greatly reduce costs by sharing resources while dynamically simultaneously playing multiple roles in the system dramatically increasing performance through flexibility. To maximize the efficiency of the system scheduler artificial intelligence (AI) can be combined with modified versions of Splunk, (Intelligent Platform Management Interface (IPMI), Baseboard Management Controller (BMC), out-of-band management (OOB), lights-out management or (LOM), Redfish enhanced scheduler that usually would play a master node functionality directing the dynamic type compute scheduling, monitoring and analytics processing with Agentic AI Autonomous Intelligence whether on a single virtual mother type board which functions as a traditional motherboard or its components or as an integral part of racks in the datacenter. The BMC IPMI functionality can be separate from the hub peripheral board or combined but would interface with the scheduler on any node that would have the scheduler delegate tasks to the job stream of the dynamic nature of the Adaptable parallel-series Cluster from the board to the HPC level. Most of the Platform Management software is Open Source similar to the Common Information Management (CIM) database DDL is readily available to modify it to adjust the grain of the data on the job and the component level instead of just on the device level and add in the job scheduling part. Augmenting the IPMI software by combining it with a scheduler to include not only what job to run and what code to load dynamically at the right time but to produce the code through Agentic AI Autonomous Intelligence allowing it to put the code through the software development life cycle (SDLC) before adding it to the version control Git and production run of the job stream cycle (or pipelines). The traditional term pipeline was most commonly used before the rise of Hadoop technologies for CPU processing that breaks processing down into multiple consecutive stages and has carry look ahead tasks that are not dependent on other tasks results held in buffers to be used when ready to maximize processing speed and efficiency. The Adaptable parallel-series Cluster scheduler can do the same pipelining much in the way a CPU does to maximize processing speed and efficiency. Since the term series is employed to have consecutive jobs or tasks that is run from result sets of a previous task, carry look ahead pipelining used in CPU optimization can be harnessed to maximize efficiency in the Job Stream.

FIG. 1 depicts one of the areas in which progress has been made is in the realm of Adaptable parallel-series cluster computer concerning high performance and energy efficiency using low watt components such as SoCs, DSPs and other energy efficient components that provide functionality of CPUs, GPU, FPGAs, ASICs normally would. The processing potential of Adaptable Computing is greatly enhanced by combining these energy efficient components with the flexibility of the Adaptable parallel-series Cluster board (Sibling Board) technology as a processing unit or as any form of intelligent embedded controller. When Adaptable parallel-series Cluster board that dynamically reconfigure themselves to dynamically play multiple roles that share resources are coupled any kind of intelligent embedded controller device, HPC technology has the ability to scale at an energy efficient manner not capable before. The disclosure is a computer device that employs Agentic AI Autonomous Intelligence to dynamically configure itself by loading generated code into its component's controllers to prefetch metadata, data and process it locally.

FIG. 1 shows an Adaptive Computing Machine can function as a low cost general purpose computer appliance that can be configured to accommodate any application with a much greater degree of performance than a generic rigid motherboard/blade based computer system. The Adaptive Computing Machine can be provisioned to the exact requirements of an application achieving performance gains only once available from expensive computer appliances with highly specialized disk controller cards. Most existing HPC servers utilize rigidly allocated expensive hardware to dedicated boards meaning resources typically can't be shared or reallocated where needed. Most of the boards in a typical HPC computing system have dedicated functionality that cannot be reassigned to other modes of operation in the system, for instance high end processing blades in typical HPC systems can't help out. Thus server sprawl typical occurs in conventional high end servers that have sophisticated components like blades or intelligent disk controllers that can remain idle where their resources could be employed in other aspects of the system especially to alleviate performance bottlenecks. Even worse is when Database appliances become saturated with concurrent users and can't dynamically reallocate resources to alleviate the situation. The Adaptive Computing machine can be configured to resemble regular motherboard, a cluster or a computer appliance that utilizes Adaptable parallel-series nodes that can play many roles in the system including a blade like processing node to a sophisticated intelligent disk controller that utilizes embedded application kernels designed for prefetching. By sharing resources between its different modes of operation the Adaptive Computing Machines Adaptable parallel-series devices resources can dynamically allocated to alleviate processing bottlenecks by combating Server sprawl where expensive hardware sits idle while it could be utilized in other forms of processing in the system. The Adaptive Computing Machine computer can be configured with a distributed Operating System or has the option of utilizing Virtualized Operating Systems. When virtualized Operation Systems are provisioned on the Adaptive Computing Machine that don't need to share their physical resources when busy on a high priority task avoids the pitfall having too many virtualized Operating Systems fighting for the same resources that occurs too often in a traditional computing server. Each and every Adaptable parallel-series node or core can have their own dedicated Operating System resources respectively while simultaneously functioning in an uninhibited virtualized distributed manner. The Adaptive computing machine has the option of employing multiple virtualized systems on either side or mode of operation of the Adaptable parallel-series nodes depending on how it is provisioned or how those virtualized systems are dynamically allocated. This means that several virtualized systems can be provisioned in any mode of operation of the Adaptable parallel-series node. The Adaptive computing machine will be able to dynamically share resources between Adaptable parallel-series nodes if its machine learning intelligent scheduler sees that resources are idle thus having the ability to maximize its resources for any conceivable configuration no matter how static to dynamic that configuration is. Utilizing machine learning the Adaptive computing machine will be able to dynamically learn what is the most desirable configurations are to accomplish the computing processing task no matter how extreme and do it in the most cost efficient energy conserving manner. By sharing resources and intelligently learning how to allocate them the Adaptive Computing Machine seeks to greatly extend the processing computing power while reducing the overall costs. Adaptable parallel-series devices will share resources between the Intelligent Disk Controller comprising of a FPGA and the blade that include SSD, Memory and CPU onboard I/O especially when those resources are idle conserving energy while boosting processing power. When usage of the Adaptive Computing Machine is low its resource manager part of the scheduler can put resources in a sleep mode thus saving energy and can quickly reallocate them when necessary. Adaptable parallel-series technology can employ function shipping and will seamlessly share resources to dramatically improve performance while saving costs. The Adaptive Computing Machine can be contain Adaptable parallel-series technology that contain multiple Adaptable parallel-series nodes that have all the functionality of a Adaptable parallel-series node as far as their modes of operation are concerned. This is especially prominent on Adaptable parallel-series nodes that are comprised of multiple Adaptable parallel-series nodes that can consist of numerous resources such as CPUs, RAM memory, disk storage and Accelerator devices such as FPGAs, DSPs, CPU, low watt Microprocessors, Microcontrollers, SoCs, ASICS. Adaptable parallel-series technology can also be implemented on the processor chip level whereas a CPU core is coupled with a specific application Accelerator as a single unit or processor core. It can be part of an Adaptable parallel-series node which is part of an Adaptable parallel-series device which encompasses the heart of an Adaptive Computing Machine.

The present Adaptive Computing Machine disclosure provides for a flexible configuration of an internal array of Adaptable parallel-series nodes arranged in board, chips or cores that can also act as sophisticated disk controllers that access to storage through a high speed common bus fabric but is not limited by the type of bus fabrics used and can be extended to emerging technologies (too numerous to mention like neuromorphic brain-like computer chips, quantum computing, Memristors and AI processors, GPUs, TPUs, APUs, and so on) and even technologies that haven't even been conceived yet. Adaptable parallel-series Agentic Ai technology that contain more than one node can have the option of being further sub-partitioned into Adaptable parallel-series cores so each of the cores can function as a processing unit or as a disk controller through the host operating system. The present Adaptive Computing Machine disclosure can employ several fabric technologies for the entire system, including the common bus and the disk controller bus or it can employ several different type of HBA (Host Bus Adapters), TBA (Target Bus Adapters) and TCA (Target Chanel Adapters) technologies like RoCE Express® and its associated technologies such as InfiniBand and its variants, iWARP, NVMe over Fabrics (NVMe-oF), Compute Express Link (CXL), Intel Omni-Path to name a few and the capabilities of PCIe version 6 and beyond depending what are more conveniently available. Adaptable parallel-series DPU cards and SOCs can employ any number of Coprocessors such as AI, GPU, TPU, APU (Associative Processing Unit), NPU (neural processing unit), MPU (Matching Processing Units), Neuromorphic Chip that mimic brain neurons, to QPU (Quantum Processing Units) and Math and Vector processors that employ smaller number formats with fewer bits and reduced mantissa geared to improve the inference performance whose resources can also be configured to be shared between the different modes of operation amongst the Adaptable parallel-series nodes. Typically AI training today uses 32-bit floating point numbers providing accurate calculations while inference neural nets usage benefits from smaller numbers that represents weighs 8-bit integer (whole) numbers. Google Brain proposed the use of called BFloat16 or Brain Float 16 number format geared for or AI/deep learning applications. This new Brain Float format reduces energy consumption needed multiplying tensors together attributed to reducing the precision of the numbers in AI processing while offering a tradeoff to traditional AI training and inference. The modular construction of the Adaptive computing machine that employs a virtual hardware design that individual components have their own boards means that of the high cost components can be optional thus allowing upgrading without having to replace entire traditional motherboard or DPU boards. The Adaptable parallel-series technology can also be used to upgrade competing technologies into Adaptive Computing Machines by integrating Adaptable parallel-series nodes into an existing system.

The present Adaptive Computing Machine disclosure relates generally to an inventive form of computer architecture that facilitates a completely modular design that is flexible enough to be applied to most tasks to improve performance in a cost effective manner. This flexible design of the present disclosure encompasses the use of identical Adaptable parallel-series boards/nodes/cores arranged in either a series or parallel arrangement by the manner that they are provisioned in the system. The Adaptive Computing machine can dynamically allocated resources by changing its mode of operation or by sharing components between simultaneous modes allocated to the same board or node to maximize resources. The Adaptive computing sophisticated scheduler that employs artificial intelligence, machine and deep learning to maximize usage of the resources in the system. Its intelligent scheduler will be able to utilize machine learning to allocate resources to maximize idle components by assigning them to extreme processing tasks that traditional computer architectures would not be able to do thus dramatically increasing processing capabilities through sharing resources dynamically in a cost effective manner. By rearranging components that typically comprise traditional computing systems Adaptable parallel-series technology can communicate through a common bidirectional bus in an uninhibited manner to share and allocate resources amongst its various assigned roles which allows access to storage fluidly and dramatically reducing I/O bottlenecks. Distributed systems, clustering and similar technologies have relied on physical network or storage switches to accomplish in one particular embodiment of the disclosure what the Adaptive Computing Machine can provide entirely in components by implementing a common I/O bus for high speed throughput to storage while placing the traditional bus controller type devices that function at slower speeds on an I/O controller hub on a common bus for external access. The Adaptive Computing machine architecture can also be adapted to Wi-Fi, traditional networking and mobile cell phone technologies to enhance I/O port performance. Any form of processing can be maximized by the Adaptive Computing Machines ability to dynamically allocate resources to eliminate or reduce processing bottlenecks in the system.

By utilizing the option of open source or commercially available such as Virtual Machine, Kubernetes, or Docker software that allocates portions of available resources is modified to recognize the Adaptable parallel-series board or nodes as distinct processing units combined with the physical arrangement of the Adaptable parallel-series nodes, it permits the Adaptive Computing Machine to be tailored to any type of specific processing in a low cost manner. By having Adaptable parallel-series boards share resources between when it functions as a processing board and when it acts as an intelligent disk controller allows dramatic cuts in cost while significantly increasing processing powering a dynamic way. Adaptive Computing Machines can use of modular Adaptable parallel-series boards of the present disclosure that utilizes an emerging high speed fiber fabric technology including Intel's Thunderbolt (Thunderbolt™ is a registered trademark of Apple Inc.) for smaller implementations, Fibre Channel, PLX Technology PCIe (Peripheral Component Interconnect Express), and or similar types of emerging Fiber Fabric Hub technologies in various topologies such as Bus, Tree (Planar, Hierarchical), Fat Tree, Star, Crossbar, Ring, Omega, Hypercube, Butterfly, Torus, Mesh, Hybrid Mesh and Hybrid fabrics that are a combination thereof (blocking and non-blocking) . . . virtualize the network IP by binding the network address. Adaptable parallel-series blades/boards/nodes eventually can even employ onboard fiber technologies to communicate with its resources to keep up with throughput between its components. The Adaptive Computing Machines flexible architecture that shares components and reallocates them where processing power is needed to alleviate bottlenecks in the system can be applied to almost any type of computing bottleneck. The Adaptive Computing Machine that utilizes Adaptable parallel-series Agentic AI technology can utilize software defined architectures such as converged or hyper-converged infrastructure where the storage and the network are virtualized. Converged architectures house local storage such as high performance SSD that cache storage from sources like a SAN or can be standalone fit with the Adaptable Computing Machine architecture. Adaptable parallel-series technology can also be virtualized to reside in the actual virtualized software as an option to configure and can also exist in software as an emulator. Technologies such as Netezza have emulator software available to their clients. Whether bare-metal or virtualized the Adaptable parallel-series technology can dramatically increase performance by its use of parallel and series connections that are more efficient that the traditional load balancing in parallel by scaling out elastically.

As Artificial Intelligence progresses the use of NLP (Natural Language processing) combined with the computational Adaptable parallel-series technology described in U.S. Patent Application Publication US20180260083A1, incorporated herein by reference in its entirety, describes using multiple separate presentation layers suited to the device being used for the visual GUI (Graphical User Interface) but also mentions a technology that is the NDC (Neighborhood is the Datacenter). Having computing devices in the home, office or in industrial settings that are capable of the Adaptable parallel-series technology described in U.S. Pat. No. 11,775,464, incorporated herein by reference in its entirety, describes, to allow for devices in the home such as gaming machines, cable boxes, smartphones, workstations and rack servers to be able to farm out processing time to various compute tasks. The future appears to be the use of AI Foundational models to not only train models but to use inference to apply NLP and other directive tasks to process RAG (Retrieval-Augmented Generation) AI that leverages vector databases to enhance Large Language Models (LLMs) by updating them with context from current external knowledge bases that improves accuracy and reducing hallucinations in a communal method. In the training of Foundational Models especially LLMs millions of dollars are spent on high end GPUs rack systems in sophisticated fiber and wire hybrid mesh point to point networks combined with switched fabric bidirectional InfiniBand architecture that use exorbitant amounts of energy sometimes enough to power whole cities. These LLM models cost can reach 100s of millions of dollars to produce the model in a reasonable amount of time between days and weeks. In California Mega Watts of energy are thrown away because the antiquated electrical grid can't absorb the excess energy produced from solar panels and other types of Green Energy. With many houses and businesses now equipped with fiber and high speed cable not to mention 5G mobile internet network today's neighborhood or Edge Compute capabilities rival datacenter networking speeds of just a decade ago. What if that wasted Green Energy could be converted to compute energy; it would be a viable energy source that would rival the biggest fossil fuel sources that many times have to drill down many miles under water than then miles on top of that even to get at the source. Even though this distributed compute would be slower the cost savings would justify it. Now that LLMs can be produced from base models either distilling them or using them as source to create new models from the datacenter starts to be less relevant. In the Neighborhood as the Datacenter could have a Datacenter Federated server such as BlueSky for example that points to where all the neighborhood webservers are to farm out processing tasks. Commerce, Social Media and so many Cloud applications can be distributed. BlueSky has attempted to start to play with this notion by putting out an open source Bluesky PDS (Personal Data Server) container which is a Federated Self-hosting Personal Data Server that interfaces with the Bluesky social network. This server can be expanded to do distributed compute tasks as well as hosting various forms of services once only done in the cloud which has come under increasing scrutiny for the enormous amounts of emery and fossil fuels needed to run them.

Workstation in FIG. 1 includes a common bus (also referred to as “backplane”) 10, hub board (also referred to as “peripheral hub board”) 120, a one or more of Adaptable Parallel-Series boards 130, 140, 150, and 160 of different types can have any networking technology mentioned here ranging from PCIe to sophisticated hybrid mesh switching fabrics, and a one or more of storage hard drives comprised of general storage arrays, only two of which are numbered, a first optional RAID storage array 170, and a second optional RAID storage array 180 which both can be capable of Adaptable parallel-series Agentic AI technology. Work station 1 includes a simple rack for mounting the one or more of Adaptable parallel-series (Adaptable Parallel-Series) boards 130 is a processing system CPU and Memory, 140 is a Adaptable Parallel-Series board that could be a DPU board or that could be Adaptable parallel-series System Manager that has its own NVMe SSD since SAS SSDs are not usually capable of GPUDirect or parallel-series processing since they don't have a Netezza Sblade embedded in the controller that comprises of usually ARM cortex CPU and some form of Memory and an embedded application in the form of an ASIC accessed by a compute kernel also known as an application compute kernel. If 40 was a workstation system manager similar to a Rack Manager it could have a sophisticated scheduler that uses Agentic AI to manage the machine using Analytics, Deep Learning and Machine Learning. In FIG. 1 150, and 160 are GPU server boards, blades or individual GPU cards in a hybrid mesh as part of the common bus 10. An Adaptive Computing Machine Workstation 1 can be a sophisticated rack that performs functions of a conventional mother board.

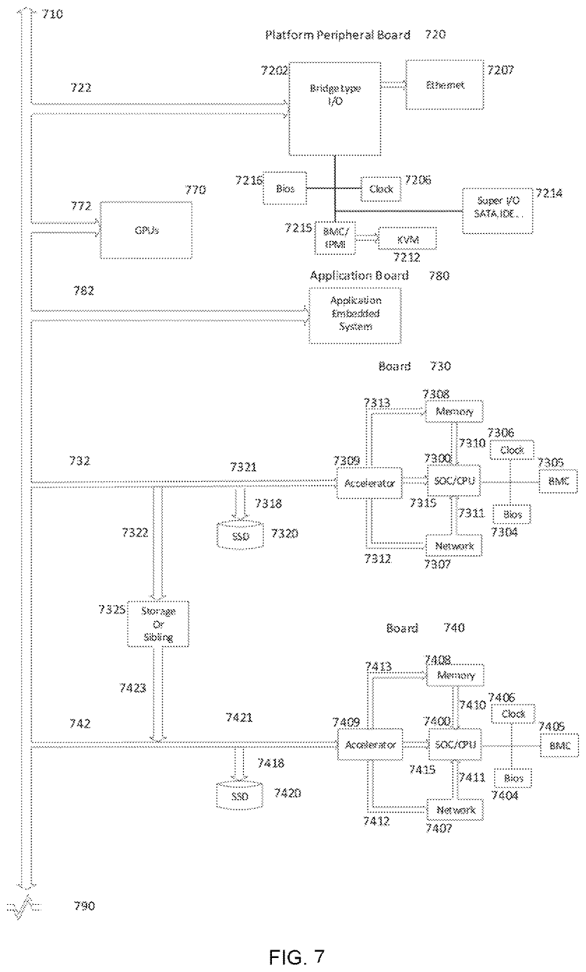

In FIG. 1 Hub board 120 physically mounts and is shared amongst a one or more of Adaptable Parallel-Series boards first and second Adaptable parallel-series Agentic AI boards 130 and 140, and additional Adaptable parallel-series Agentic AI GPU boards 150, and 160, which are depicted as optionally as four in the present embodiment described in FIG. 1. Hub board 120 is optional considering that the main system motherboard can range from a traditional motherboard to having each component having a separate board to lower the impedance and thus the heat efficiency of the system. This is known as virtualized hardware. Therefore Hub board 120 that can be dumb or Agentic AI wise is optional as opposed to having a full motherboard instead. If using an AMD EPYC chip the HUB board is in the chip, therefore the Hub board can be a separate Agentic AI RMC (Rack Manager Controller) that can be proprietary or an Open Source augmentation such as the Open RMC project on the Open Compute Project. If Intel is used, then a Hub board PCH (Platform Controller Hub) chipset can be found on the system CPU and Memory motherboard instead as such with traditional motherboard designs. It could also have a workstation BMCs to monitor its operations other than bios and OS monitoring like what Windows or Linux does. Each of first and second Adaptable parallel-series Agentic AI boards 130 and 410 includes a first optional local onboard storage 170 or a second optional local storage 180 as illustrated in FIG. 7 as individual SSDs or part of a Storage Array. For the Adaptable parallel-series Agentic AI board's Operating System usage part of the Adaptable Parallel-Series board and typically is distributed across the various blades in the system using MPI type distributed libraries among individual OSs, or various cluster OS RASC Rack-Scale Computer Systems similar such as RackSched, LegoOS, RackBlox, Intel RSD that are still in development stages to name a few. An optional onboard Adaptable Parallel-Series board (preferably SSD not shown) storage 170 and 180 respectively (not shown in FIG. 1) are employed to house the Adaptable parallel-series Agentic AI boards. These Adaptable Parallel-Series board local storage drives 170 and 180 are displayed as part of the Adaptable Parallel-Series board units 130, 140, 150, and 160 that can be virtualize hardware comprising of one or many boards as a single unit in FIG. 1. First and second optional onboard storages which reside on the physical Adaptable parallel-series DPU board (not shown) function as extra general purpose local data storage hard drives and are capable of local RAID (Redundant Array of Independent Disks) storage.

First and second Adaptable parallel-series Agentic AI boards 130 and 140 are stacked together. Thus, one of advantages of the present disclosure is that the one or more of Adaptable parallel-series Agentic AI boards can be configured to be more compact and manufactured for a low price because the one or more of the boards can be connected to each other or to the hub board 120 that includes a scaled down RMC rack manager controller that interfaces with BMC or BMC type functionality on the various other boards connected with various network hub and spoke such as PCIe, or various switched fabrics point to point hybrid mesh or combinations of both in hybrid mesh configurations which is usual for GPU or IPU Accelerated AI boards which are combinations of CPU and GPU usually packaged together.

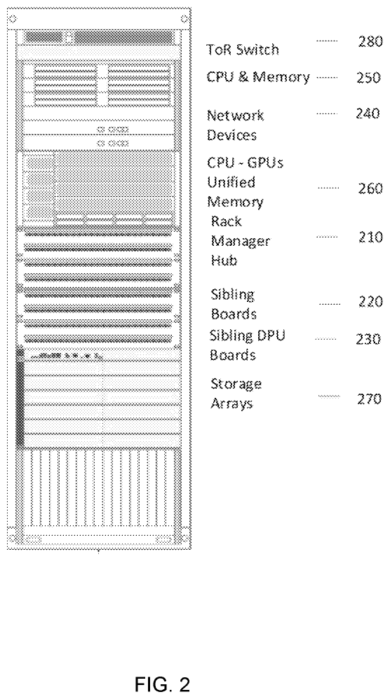

FIG. 2 is an elevational view of datacenter Rack Server where implementing Adaptable parallel-series Agentic AI technology showing an example of the structure thereof. Referring to FIG. 2, an Adaptable parallel-series Agentic AI implementing the present disclosure's Adaptable parallel-series Agentic AI boards is depicted as Sibling boards 220. The Adaptive Computing Machine shown in FIG. 2 includes High performance CPU with optional local Memory 250 which is assessable by GPUs and CPUs through RDMA, a high performance network technology 240 managed by a ToR 280 that includes power supplies, centralized cooling devices, sensors networks, and other technologies that would be common to support Adaptable parallel-series Agentic AI Sibling boards 220 operational functionality and governed by a suite of fabric and networking devices 240. Hub board (also referred to as “peripheral hub board”) which can take the form of a Rack Management hub 210 or a complete Rack Server Architecture management system or a derivative thereof, a one or more of Adaptable parallel-series DPU boards 230, an optional one or more of Unified Memory Device type boards 260 that utilize Adaptable parallel-series technology are specifically designed to utilize a pooled Unified Memory Bank that is accessible throughout the CPU-GPU mesh network by other GPUs and CPUs on network, and a one or more of storage hard drives comprised of general Storage Arrays, only two of which are numbered, a first optional pooled storage arrays 270 can comprise of Adaptable parallel-series DPU boards 230 that have been configured with appropriate networking hardware and provisioned to function as high performance Storage Arrays with RAM cache and accompanying SSDs to act as embedded application accelerator controllers and can include standard Storage Arrays that all can employ RAID and other High Availability (HA) configurations. Adaptable parallel-series can function as DPU Boards 230 have a dual nature of having the capability of having a Host side which can appear to act like a conventional computing Blade coupled with a flexible embedded application controller that acts as an Accelerator offloading jobs from CPU to the onboard Accelerator such as specific Big Data, Database or customized Algorithms optimized for prefetching data and caching it locally for the next stage of processing. Adaptable parallel-series functioning as a Sibling board 220 or can be an employs Deep and Machine Learning AI combined with previous run job metadata and analytics it transform from a traditional parallel-series Agentic Sibling boards 220 can be configured to play almost every role in the system since they can also act as a Memory pool with Unified Memory CPU and GPU through RDMA, Network or Storage controller or a convention host computing blade. Since it's able to load application code dynamically sourced from the scheduler that employs Deep and Machine Learning AI combined with previous run job metadata and analytics it transform from a traditional parallel-series Nodes to an Agentic Nodes. Not only can the Agentic scheduler residing on Rack Manager 210 that utilizes databases and Rack management software be centralized but it can also assist Sibling boards 220 or DPU boards 230 to employ Agentic AI thus any Adaptable parallel-series node or device can in theory become an Adaptable parallel-series Agentic node or device. Therefore they can be deployed as Unified Memory Controllers that function as a centralized application embedded Unified Memory Unit 260 network typical of a Mesh, Hybrid Mesh-Tree, Fat-Tree, NVLink, and Dragonfly and even InfiniBand that all support Unified Virtual Memory. Harnessing Rack Scale Architecture which relies on pooled resources such as Unified Virtual Memory is a natural fit for an Adaptive Computing Machine that is comprised of Adaptable parallel-series Agentic DPU technology. Adaptable parallel-series Agentic DPU Boards 230 can be deployed along with Agentic Sibling boards 220 as a centralized Storage Unit or a centralized Network device that could include Switches, Bridges and Router devices for a Data Center. Even though by their default dual nature a Adaptable parallel-series Agentic DPU board 230 can also be deployed to act specifically as Bidirectional controller that can be a host or target with elements of the host side of the card to augment its flexible dynamic functionality. Adaptable parallel-series DPU 230 technology can be used in a generalized all-purpose application embedded computing node or part of a centralized specific area in the Data Center similar to roles that would be in a Workstation configuration. For instance a centralized In-Memory suite of Rack Units that utilize Adaptable parallel-series DPU Boards 230 as embedded Memory Accelerator controllers can be accessed and shared throughout the Data Center whose role could be compared to Memory in a conventional Workstation. Adaptable parallel-series Agentic DPU Boards 230 can optionally dynamically be configured to be used as Storage controllers that act as Bidirectional embedded Application Accelerators to a Storage Unit that can include separate conventional Storage devices such as traditional hard drive bays. Therefore the Adaptive Computing Machine in FIG. 2 can be configured to play almost any specific specialized role in the Data Center or as an all-purpose computing device. The Adaptive Computing Machine includes a rack for mounting optional technologies including but not limited to Unified Memory bank 260, storage, management or public and private network Switches 240, and Top of the Rack (ToR) switch 280 that harness sophisticated fabrics that can include Fibre Channel, InfiniBand and its derivatives and variants, PLX or similar technologies that allow a PCIe bus to act like a TCP/IP network, iSCSI Extensions for RDMA (iSER), SMB Direct, SCSI RDMA Protocol (SRP), Fibre Channel over Ethernet (FCoE), RoCe etc. in any combinations or consolidation thereof in various topologies such as Bus, Star, Crossbar, Ring, Tree (Planar, Hierarchical), Fat Tree, Omega, Hypercube, Dragonfly, Torus, Mesh, and Hybrid fabrics that are a combination thereof (blocking and non-blocking) . . . to communicate with other racks.

In FIG. 2 a Rack Manager Hub 210 can be considered independent outside interface whose primary function provides system console management, system level diagnostic, health monitoring, and performance tuning capabilities that is shared amongst the one or more of Adaptable parallel-series nodes. The hub can but not necessarily have an I/O controller, peripheral hub chipset, RMC (Rack Manager Chip) SOC, memory and even local SSDs that interfaces with server blades BMC chip (Baseboard Management Chip) , or other Rack Management technologies which includes a main outside the system communication chipset similar in functionality to that of the Southbridge or peripheral hub chipset in that communicates via locally or remotely with peripheral console keyboard, monitor and optional pointing device which typically is referred to as Keyboard, Video and Mouse (KVM) switch or board/rack management functionality. However Adaptable parallel-series Cluster blade or board can reside on a traditional motherboard as well. The hub board was implemented to reduce the overall impedance of the motherboard but if its water or refrigerated then a traditional motherboard that does Adaptable parallel-series Cluster board (Sibling Board) is perfectly feasible. The hub board when in the form of a RMC equipped with a sophisticated scheduler can contain a database such SQLite, MySQL, PostgreSQL . . . and database design with enhanced CIM or Redfish schemas to handle scheduling and code generation that employs Agentic AI Autonomous Intelligence on the Adaptable parallel-series component to cluster level. The one or more (one or more) of Adaptable parallel-series boards is coupled to the hub or portion thereof by a communications bus for purpose of console administration to provide boot management or troubleshoot the system in single user mode however doesn't preclude access while the system is functioning normally. The hub can be simple for small systems as a single board that utilizes the Common Bus or scale to a Rack Scale Architecture (RSA) with Baseboard Management Controller (BMC) that utilizes Intelligent Platform Management Interface (IPMI) interface that includes a separate communication channel or bus. However it can include a BMC SOC that is capable of processing data from an onboard Adaptable parallel-series SSD involved in Rack Management database processing and scheduling analytics. Often in larger systems the Southbridge chipset functionality is implemented with specifically designed BMC chipsets that include some form of System Management Bus (SMBus). Its functionality includes but is not confined to monitoring the physical state of servers, computers or other hardware devices with help of sensors and can connect to a system Backplane. The Hub communicates with Adaptable parallel-series technology in the system via an independent connection whose management functionality can consists of a system boot loader, Power, Current, Voltage, Operating system and Network health, Fan Speed, Humidity, Temperature and overall management that provides an interface to connect to the remote or local KVM or serial terminal devices that is capable of acting as a system console to the system. It can interact with the System Resource Manager concerning fault tolerance, scheduling, resource management, system statistics, messaging health monitoring and logging. The hub can also include CPU, Memory, SSD and other typical blade components to enhance its overall functionality. Portions of the BMC can also reside on each Adaptable parallel-series board in the Adaptive Computing Machine to enhance its overall system capabilities. In addition the BMC functionality can include such functions as guided diagnostics, logging events for error analysis, interface with monitoring sensors, and console redirection which can have a Graphical User Interface (GUI) that can be console or Web based. The Hub and Adaptable parallel-series nodes can employ Message Passing Interface (MPI, MPI, MPICH, OpenMPI, MVAPICH etc.) and Message-oriented middleware (MOM) (such as JMS API, AMQP, MSMQ based like MQ Appliance, RabbitMQ, ActiveMQ, StormMQ, SonicMQ, MSMQ etc.), and Object Request Brokers such as CORBA, WCF, Orbix, SOAP, RMI etc.), Inter-process communication (IPC) and remote procedure call (RPC) messaging to communicate with the rest of the system over the common bus or a separate dedicated system management bus. However the market is moving towards Rack Scale Architecture which allows for pooled resources such as Memory, Storage and Compute zones to be accessed and managed by Pooled System Management Engine (PSME) which includes Rack Management Module (RMM) which is a component of the PSME that effectively is the Rack Manager. The OpenStack Foundation has published guidelines to how to implement Rack Scale Architecture (RSA) and the Adaptable Computing Machine based on Adaptable parallel-series boards fully embraces it. The power of RSA is its ability to manage pooled resources effectively. Since Adaptable parallel-series boards can dynamically play many roles in the system RSA is a natural fit. Rack Managers in the past have been implemented typically with Ethernet but if they are to be involved in Fabric Management then they logically must be able to connect to the Fabric resources in a seamless manner. Whatever future cluster management systems emerge the Adaptable Computing Machine comprising of Adaptable parallel-series boards can harness it. The concept of the Hub in the Adaptable Computing Machine can be a single board or conceptually comprise of several boards that function together as a unit to manage the system using Agentic AI Autonomous Intelligence to adjust the functionality and performance as the system sees fit.

In FIGS. 1 and 2 a Common Bus can be considered the primary communication bus of the Adaptive Computing Machine and is considered the backbone of the system. It generally is a high speed bus that its foremost implementation would consist of Optical Fiber but not confined to thereof. In a particular embodiment, it offers the ability of seamlessly connecting Adaptable parallel-series nodes in parallel or in series as a disk, memory or network controllers for other neighboring Adaptable parallel-series nodes as well as storage contained in them or in a centralized location. The Common Bus doesn't have to be reliant on one type of high performance fabric technology but can include numerous types of fabrics working together with their associated channel or bus adapters either single or bidirectional. Depending on what is appropriate for the size and complexity of the machine that Adaptable parallel-series technology is implemented on the number of fabrics that can reside on the Common Bus can be numerous including System Management Bus and TCP/IP based Ethernet via various devises including switches, bridges and routers. The Adaptable parallel-series nodes physically attaches to the Common Bus that optionally connects to the Peripheral Hub devices which can include Rack and Pod Managers and receives its I/O support from it but doesn't have to be mandatory especially on larger complex HPC systems. Many Rack and Pod Managers use Ethernet networking devices with the option of fiber that have Web Rack Management applications and Services that employ Representational State Transfer (REST) API, in conjunction with Redfish API as part of Rack Scale Architecture to communicate with the rest of the HPC clusters that have Web based Management Systems. The Common Bus usually is used for Adaptable parallel-series nodes in a rack to communicate but isn't confined to it, which can be used in conjunction with or a separate traditional high speed TCP/IP Ethernet based Network system that also optionally can be Optic Fiber on the host or controller side of the Adaptable parallel-series devices. The Common Bus can consist of various storage fabrics that aid in efficient single or bidirectional controller access and can also contain a self-contained traditional TCP/IP network implementation such as PLX technologies or similar there to. The TCP/IP based network can be traditional or Optic Fiber based depending on the type of common bus fabric technology employed. Certain fabric implementations such as PLX's Optic Fiber technology which was innovative for its time which provides a TCP/IP like network over the Common Bus to a pod of Adaptable parallel-series DPU boards don't require typical as many onboard networking devices but don't exclude the use of them either. It is common to have SmartNICs that have multiple ports to allow for flexible networking whether it's Ethernet or Storage Fabric based. The Adaptable parallel-series technology is designed to be able to implement complex networking topologies by virtue that it includes onboard potentially numerous bidirectional fabric connections in combination with numerous high performance Ethernet devices to be able to freely implement parallel and series (near neighbor) connections that employ application embedded acceleration that can be generated by Agentic AI Autonomous Intelligence.

In FIGS. 1 and 2 a Component Bus can be considered the communication bus of Adaptable parallel-series Cluster nodes itself and can consist of various technologies. Anything that physically resides on the Adaptable parallel-series node that communicates with other technologies locally on the board or what is considered part of can be considered generally to be part of the Component Bus. PCI express (PCIe), NVMe, Northbridge multi-channel high bandwidth memory buses are some of the foremost current system bus interconnect, and soon the advent of off board, onboard and inboard Optic Fiber technologies will enhance performance. Some SmartNICs are currently employing fiber to the board to enhance HPC computer performance. Accelerator memory interconnect fabric technologies like Open Coherent Accelerator Processor Interface (OpenCAPI), Cache Coherent Interconnect for Accelerators (CCIX) and GEN-Z, that intend to outperform traditional native PCIe interface and its associated technologies which show the need for higher Component Bus performance and flexibility which eventually Optic Fiber will play a role for HPC specific high performance IC interconnect. Emerging transistor technologies that seek to utilize light will hopefully be able to integrate Optic Fiber technology system bus technology that dramatically increases the performance of computing. On-board optics (OBO) as a viable Optic Fiber technology system bus will soon be the norm in the Data Center where Adaptable parallel-series DPU board with neural processing NPU capacities combined with Agentic AI will be able to take full advantage of parallel-series processing by prefetching data processing AI and traditional data to pass result sets in to other accelerated Adaptable parallel-series Cluster board (Sibling Board) components such as GPUs or Adaptable parallel-series Cluster board (Sibling Board) storage. However off board Optic Fiber technology that connects SmartNICs Accelerators is being used today which will only expand its capabilities using Agentic AI Autonomous Intelligence to envision how to maximize data throughput throughout the HPC computer at speeds that exceed today's high speed performance.

In FIGS. 1 and 2 there are many options as far as cabling and connectors that can be used by the Adaptive Computing Machine parallel-series technologies. Optic Fiber allows for Gigabit speeds that can travel distances. There has been an expansion of cabling technologies in the Data Centers in which there are many connectors on the market. Typically the most popular are Small Formfactor Pluggable (SFP) and Quad Small Formfactor Pluggable (QSFP) connectors whether copper or fiber is used and have many derivatives. Direct Attach Cable (DAC) tends to that makes use of non-optic transceivers when Twinaxial copper cabling or “Twinax” coaxial cable is used and optical transceivers when fiber is used. Fiber technologies come in single and multiple channels where singular is used for long distances and multiple channels for high data transfer speeds which make it more popular for interconnect in the Data Center. Active Optical Cable (AOC) which uses 4-Channel full-duplex bidirectional optical fiber between the connectors that take the same electrical inputs as copper cable and supports InfiniBand, Fibre Channel SAN, SAS, SATA, Ethernet and so on and thus is becoming very popular. Silicon Photonics offers the promise of dramatically higher data transfer interconnect rates with the integration of optics onto silicon technology and soon on-board fiber chip to chip interconnects will soon become a reality in the marketplace. In the near future programmable optical chips will be able to offer similar functionality to FPGA accelerator technology will dramatically increase ultrafast signal processing. Thus the concept of on-board, in-board along with current off board fiber interconnects will all be capable of being harnessed by Adaptable parallel-series Cluster board (Sibling Board) technology. Adaptable parallel-series technology that allows for flexible processing due to its ability to process data with Parallel and Series connections combined with emerging fiber advances empowers the Adaptable Computing Agentic AI Autonomous Intelligence Machine as the computer architecture of the future.

In FIGS. 1 and 2 a Channel Adapter can take many forms depending on the type of Fabric that is employed. With the advent of numerous competing fabric technologies the need to generalize them into some form of host and target reference is necessary to refer to Adaptable parallel-series technology in a generalized manner. Open Source OVS Open vSwitch SmartNICs technologies that have powered technologies that are used by all the major tech companies such as NVidia have been around since 2011. Having OVS libraries embedded in controllers that function like Netezza S-blade to facilitate parallel-series processing with other components on the board or in the system utilizing RDMA can be enhanced by NPU to include neural processing and FPGAs or GPU. There are generally three fabric categories that the OpenFabrics Alliance recognize even though there exists numerous proprietary derivations and customized fabrics which would be too numerous to include all of them (Fibre Channel Protocol, iSCSI Extensions for RDMA (iSER), SMB Direct, SCSI RDMA Protocol (SRP), Fibre Channel over Ethernet (FCoE) etc.). Traditionally InfiniBand has designated that Host Bus Adapters (HBA) and Target Channel Adapters (TCA) were used to connect hosts to respective storage. Channel Interfaces such as iWARP use RDMA enabled NIC (RNIC) while RDMA over Converged Ethernet (RoCE) refer to channel interfaces as NIC. InfiniBand has defined Verbs as the required behaviors that are necessary to implement message service protocol and efforts have been made to consolidate them over competing technologies. In light of running InfiniBand directly over Ethernet which these technologies strive to accomplish there needs to be a way to refer to all of them including those not listed here in a single coherent manner. In doing so traditional InfiniBand HBA and HCA adapters are implemented in Ethernet and are capable of calling the OFA InfiniBand API calls over Ethernet that use MPI, RDMA or derivations thereof. Where TCP provides a reliable in-order sequence of bytes RDMA provides a reliable in-order of messages. Current RDMA implementations over Ethernet such as RoCe v2 can do Kernel bypass and offloading and can have IP routable packet format that is capable of processing on L2 Ethernet Switches and L3 IP Routers while doing asynchronous data transfers and transfer data from one virtual node memory to another. Thus host bus and target channel adapters will be generically referred going forward as HBA and HCA/TCA respectively for the purpose of documenting and diagraming them and represent logical high level representations. These adapters can reside as hardware or software implementations depending on what type of fabric technology is used. However there are many competing technologies such as NVLink that are employed to connect GPUs with a mesh network thus combining PCIe and networking bridge technologies in a single blade or board. With the market moving so fast what was popular at the time can change in a few short years. Years ago one would have separate storage fabric and Ethernet networks devices and networks whereas today the industry is striving for one physical network fabric that can handle it all over Ethernet. At the same time PCIe and NVMe technologies almost rival NVLink and can be used together to form parallel-series complex hybrid mesh networks between individual components especially GPUs. The reference of bidirectional generically will be used hence going forward to mean for an array of bus and network adapter technologies are consolidated and combined to allow a host to also be a target with is the underlying principle that allow parallel-series boards to access each other's resources. Switched fabric architecture technologies that provide the benefits of RDMA but employ proprietary adapter functionality similar to InfiniBand type processing can also be represented with the logical representation of source HBA and HCA/TCA represented here. HBA and HCA/TCA are represented in the diagrams to reflect a myriad of possible bus, network or fabric combinations so they have been not highlighted with separate box illustrations. Though it can be interpreted to mean that emerging NVMe-of technologies that don't use RDMA libraries but provide similar functionality can be represented by the terminology regardless of the type. The logical representation of channel adapters is flexible enough to denote the use of a bidirectional fabric that employs RDMA functionality whether it employs it or its features like it.

In FIG. 2 an Adaptable parallel-series Boards usually contains CPU, Memory devices, Bios, Platform Controller Hub (PCH) type chipsets, optional BMC and BMS communication devices, an Accelerator device, a board clock and a one or more Chanel Adapters that can implement multipathing for which allow for flexible usage in the system including a bidirectional connection to the Common Bus not possible by conventional motherboard/blade designs. They have the capability to have their own operating system and Virtual Machines that can be different from other Adaptable parallel-series technology can also be applied to Peripheral Hub 110 of FIG. 1 or Rack Manager Blades 210 of FIG. 2 and optionally connect to the Common Bus depending on what type of management technology is used. Adaptive Computing Machines at their heart have a modular design doesn't preclude an Adaptable parallel-series processing blade, board, component, IC down to the portion of an IC from having to playing multiple possible roles. Adaptable parallel-series technology can be implemented strictly as controllers that are solely intended use is to make parallel and series connections with other Adaptable parallel-series controllers. Adaptable parallel-series technology can also be employed in traditional HPC clusters where their duality of acting like a host or traditional blade augmented by Agentic AI Autonomous Intelligence in the system as well as embedded memory, storage or network controllers can great enhance specific types of processing such as Web Ranking, Analytics, and Scientific, Big Data, and Very Large Database VLDB applications.

The modular design of adaptable parallel-series technology shown in FIGS. 1 and 2 from a high level is Universal, meaning one term for the technology can be populated to play almost any role in the system from the IC up to the datacenter rack depending on how it is configured and it is meant to be upgraded, repurposed or reconfigured easily. Adaptable parallel-series servers/blades/boards/components/nodes/ICs can be configured as a master or a slave depending on how they configured. A master is referred to as a Head node in Beowulf cluster terminology and as a control node in the Rack Space Architecture (RSA) terminology coined by the OpenStack Foundation. Usually at least one node needs to be provisioned as the Master node in the rack, however it doesn't preclude a centralized Master Pool in the Data Center that comprises of many Adaptable parallel-series nodes. The Master node or Control node acts plays a vital role in the system that includes Resource, Networking, Identity, Fabric, Storage, Scheduling and Orchestration management and supports global agents and service management. However other boards can dynamically assume the role of the master node or several master nodes can be configured in a fault tolerant configuration. The Master Node's job is to not only manage all the nodes in the system defined by the OpenStack Foundation but also is the primary area for the Adaptive Computing Machine to utilize Artificial Intelligence and Machine Learning to learn what is the most effective manner in reconfiguring itself to run specific resource intensive jobs in the most efficient and effective manner. The Adaptive Computing Machine can make use of Open Source job schedulers such as TORQUE, SLURM, ProActive Parallel Suite, and Maui Cluster Scheduler to name a few and modify them to handle the dual nature of employing Adaptable parallel-series technology applied to the Rack Manager which can be ToR (Top of the Rack), EOR (End of the Rack, MOR (Middle of the Rack) or where it's appropriate . . . High end Database and Web server systems have used internal management systems to schedule, track and manage everything that runs on the system to present bottlenecks in a management dashboard as if it was a Business Intelligent application. The master node can be thought of as including the Cluster Management Dashboard system that is autonomous and is completely capable of employing AI and Machine learning to manage itself for most issues. The Master node can have an HA configuration where it can failover to another separate Adaptable parallel-series nodes that is designated as a backup while it still can function as a Compute node. The master node can also handle manage Storage whether it is shared or in a shared nothing configuration. The master mode can be used to allocate quorum or voting drive areas and overall Storage management. Since the Adaptable parallel-series hardware for the Control node is almost identical to that of a Compute node, the master node can also dynamically act as if it were a compute node if its resources allow it to further extending the efficiency of the Cluster. One of the main functions of the Master or Control node in an Adaptive Computing Machine (ACM) that employs Adaptable parallel-series node is Configuration Management since the Adaptive Computing Machine can dynamically changing its configuration to suit the job stream. Adaptable parallel-series technology allows for parallel and series processing that is not capable with traditional HPC computers. A series connection is defined as an Adaptable parallel-series node whose controller side accesses prefetch data from another Adaptable parallel-series node for further processing. It is the role of the Master or Control Adaptable parallel-series node to designate, track and learn about how to jobs can make use of dynamic parallel and series connections to process data in the most efficient manner possible. When Adaptable parallel-series Agentic AI Autonomous Intelligence technology is employed in Slave or Compute nodes its dual nature of having the capability of acting like a host or an embedded application controller accelerator. For instance take a Big Data or high end database server that employs a database engine kernel inside the Adaptable parallel-series DPU or Storage boards/components controller side, large queries with intensive large data sub queries could be processed in stages so that once results are processed in parallel in the first stage they can be further processed by other adaptable parallel-series nodes that connect to the prefetch data results cached on adaptable parallel-series nodes in the first stage for further stages of processing. A database will be able to dynamically configure the Cluster to process data by utilizing parallel-series connections governed by its optimizer. Query plans will be processed by the Master or Control node to allocate Slave Compute nodes to process data in stages of parallel and series connection by virtue of the query plan. Currently there are database systems that claim that very little if any human intervention is necessary anymore and that the role of the Database Administrator is obsolete by virtue of using a sophisticated operational data warehousing technology coupled with analytical processing to automate most tasks. By tracking all of the jobs it schedules in a repository and creating analytics from their history all aspects of what resources were consumed the Adaptable Computing Machine can learn to tune and manage itself.

In FIGS. 1 and 2 Adaptive Computing Machine utilizes adaptable parallel-series Agentic AI Autonomous Intelligence technologies which can comprise of numerous Adaptable parallel-series Nodes on numerous levels to be able to physically adapt to any computing stream in a cost effective manner unlike any conventional computer. The Adaptive Computing Machine seeks to eliminate “server sprawl” and I/O bottlenecks while cutting costs of a traditional computing system by sharing resources that are typically dedicated to either a motherboard or a sophisticated embedded intelligent controller. According to one aspect of the present disclosure, an Adaptive Computing Machine system includes first a Pod and or Rack Management Module 210, and a one or more of Adaptable parallel-series DPU 230 boards all attached to a Common Bus that takes many forms and may include some form of network Ethernet devices 240, In-Memory array and common Storage Units 270. Adaptable parallel-series DPU boards 230 have the innate ability to be the controller of any kind of controller in the system depending what software is embedded them, therefore anything that can be incorporated into the system bus can benefit for Adaptable parallel-series Agentic Ai technology and thus be considered an Adaptive Computing Machine. Embedding Adaptable parallel-series technology into SSD unit's flash controller can greatly enhance prefetching of data is just an example. Storage units, Network and Optic Fiber I/O devices 240 that comprise of Adaptable parallel-series technology can greatly improve performance and scalability while still serving as a crucial component of the Adaptive Computing Machine. Adaptable parallel-series Boards 220 usually contain CPU, Memory, Bios, and Accelerator that comprises of FPGAs, DSPs, ASICS, SoCs which contain some form of APU/NPU and most of the functioning components of regular processing board or intelligent controller combined into one resource that shares components. A one or more of onboard Host, Target or Channel Bus Adapters allows Adaptable parallel-series nodes flexible bidirectional usage in the system not possible by conventional motherboard designs. Adaptable parallel-series nodes have the capability of having its own operating system that can be different from other Adaptable parallel-series boards using the same Peripheral Hub or Cluster Manager board/device/system and or Common bus. At least one of the Adaptable parallel-series blade/board/nodes in the Adaptive Computing Machine acts as the Master blade/board/nodes or head node, that can also be referred as a Controller blade/board/nodes that manages the common bus by which the other slave or target Adaptable parallel-series Agentic AI Autonomous Intelligence blade/board/nodes communicate with. Each of the Adaptable parallel-series boards has the option of having a dedicated local hard drive, preferably a solid state drive. These SSD type drives can also utilize Adaptable parallel-series technology in their flash controllers and can even utilize low cost mechanical hard drive technologies for failover and archival purposes. The main concept of Adaptable parallel-series Agentic AI Autonomous Intelligence technology is that one node can flexibly take on many roles dynamically by producing code on the fly to load into component controllers while having the option of sharing common resources. These roles can range for the functionality of a processing board to any type of intelligent controller in the system. Adaptable parallel-series DPU boards 230 can have numerous modes of operation but rely on having more than a single role in the system. An Adaptive Computing machine can also integrate traditional blade computing boards/devices 250 either by way of semi populating a modular Universal board or an industry standard blade computing device. Adaptable parallel-series nodes can be dedicated to a subset of the possible roles it can play such as a DPU. GPU, SSD or intelligent Network device. An Adaptable parallel-series node doesn't have to exhibit all possible roles in a computing system to be a true Adaptable parallel-series Sibling node. Adaptable parallel-series technology has a host or conventional blade side that shares its resources with an embedded application accelerator controller that prefetch data from the system simultaneously. In chip form Adaptable parallel-series technology would couple a CPU with an embedded application Accelerator as a core of the multicore chip with NPU capabilities. Thus being able to use the CPU in conjunction with an embedded Accelerator in a multithreaded manner would allow for the chip to reconfigure its data paths much like an Adaptable parallel-series node would. Adaptable parallel-series technology can be configured to play a dedicated role in the system or it can simultaneously play the role of an In-Memory, Storage 270 or Network controller 240 as well as a host or conventional blade. By sharing computing component that are usually dedicated Adaptable parallel-series technology can maximize performance efficiently. As long as a computing node has the flexibility to handle more than one mode of operation that typically used to reside in a traditional computer as separate boards or nodes it is a form of an Adaptable parallel-series devices. Adaptable parallel-series DPU boards 230, wherein at least one of the one or more of Adaptable parallel-series technologies that functions as either a processing unit or a storage disk controller of the host board while others can be Adaptable parallel-series GPU banks that its offloading processors can be enhanced with compression, decompression, hashing, encryption or any application algorithm including AI. Adaptable parallel-series technology can also accommodate up and coming technologies such as Memristors, AI chips and any other kind of emerging technology. The Adaptable parallel-series technology of the present disclosure alleviates the prior art problems of complexity and expense of having to replicate components to dedicated resources.

Furthermore, the present disclosure has the capacity to accommodate any form of emerging technologies in areas such as HPC clusters, distributed systems, and computer appliances, workstations, PDAs, embedded devices and eventually even cell phones. Eventually Adaptable parallel-series boards/components/IC can have onboard embedded fiber connections to maximize performance and PCI express root fiber switches that can direct high performance traffic amongst major component's residing on either side of the Adaptable parallel-series boards/components being CPU, RAM, SSD Disk or FPGA or any facsimile thereof. Adaptive Computing Machines that are intended for the consumer market could not only run many resource intensive applications simultaneously but would be capable of employing multiple user interfaces that range from a cell phone PDA interface to a Server and everything in-between. Any computing component that can successfully function in the market place can benefit from the Adaptive Computing Machines system architecture. Low wattage computing components that facilitate high speed vector processing and heavy number crunching can be incorporated into the Adaptive Computing Machine. The Adaptive Computing Machine can also adapt to utilizing the right component by factoring in numerous variables like its heat dissipation from DTS (Digital Thermal Sensor), power consumption, speed to effectiveness when multiple components can handle the task. When these components are shared amongst the different roles that the Adaptable parallel-series technology can be engineered to perform, performance and efficiency are greatly enhanced over other types of computing design.

In FIGS. 1 and 2 whereas existing technologies extend the functionality of a disk controller card by embedding Field-Programmable Gate Array (FPGA), function shipping, low watt DSPs and SoCs, GPUs, AI coprocessors are combined with other high speed memory cache devices for the purpose of filtering and prefetch metadata or data in parallel, Adaptable parallel-series technology (comprising of either boards, nodes or cores) share these components amongst its various modes of operation increasing performance by virtue of parallel and series nature of connecting to resources while cutting overall costs. Thus, a single Adaptable parallel-series node is capable of being flexible enough to be utilized as a host board, a target board or as an embedded intelligent controller that can utilize FPGAs, DSPs, CPUs, low watt Microprocessors, Microcontrollers, SoC, (Customizable System on a Chip) CSoCs and Memory Cache and so on depending on how it is configured. By sharing local resources on the local Adaptable parallel-series node bus instead of opting for dedicated resources on separate cards, the Adaptable parallel-series node efficiently increases performance and functionality. In a particular embodiment the Adaptive Computing Machine offers an option of seamlessly connecting to a common bus in parallel or to other Adaptable parallel-series boards in series as a controller of controllers regardless of what type of controller it's functioning as. In a low cost version of Adaptive Computing Machine Adaptable parallel-series nodes connect to the common bus as well as communicate with the neighboring Adaptable parallel-series nodes as a host processing unit or as its disk, memory or network controller, and all the connections are available onboard to be able to play any of these roles and can be provisioned according to the host operating system. How complex the permutations of the combinations of parallel or series configurations depend on how many boards are connected to the system and type of fabric topology is employed which can range from fiber implementations to emerging technologies since the type of high performance I/O shouldn't affect the overall functionality of the embodiment of the disclosure. The Adaptive Computing Machine can be a high end HPC machine with complex fabric permutations governed by a sophisticated Fiber Channel Adapters or network devices that utilize Adaptable parallel-series technology internally to manage combinations of parallel or series configurations. Embedding Adaptable parallel-series technology into fabric controllers 240 and 260 enables complex topologies that form of sophisticated fabrics such as InfiniBand including in various topologies such as Bus, Star, Tree (Planar, Hierarchical), Fat Tree, Hub and Spoke, Crossbar, Ring, Omega, Hypercube, Dragonfly, Torus, Mesh, Hybrid Mesh, and Hybrid fabrics that are a combination thereof (blocking and non-blocking) . . . , these include NVLink, RoCEv2, Fiber Channel, 3GIO, Gigabit Ethernet, and RapidIO . . . i.e. to filter and prefetch data from the fabric devices ranging from switches, bridges or routers including combinations of each. The Adaptive Computing Machine that utilizes Adaptable parallel-series technology can range from a smartphone, PDA device to everything including a HPC computing machine that makes use of the leading edge technologies. Almost any kind of emerging technology in any size or configuration can benefit from Adaptable parallel-series technology by improving performance by not only sharing resources but cutting costs. Adaptable parallel-series technology can even reside on the chip and can include technologies such as FPGA, DSP, SoC, CSoCs, GPUs, TPUs, APUs and all forms AI coprocessors, as well as emerging technologies that could function as an application embedded accelerator in its Adaptable parallel-series technology. This chip would be capable of housing many local Adaptable parallel-series nodes while can also be configured with more traditional microprocessor microcontroller technologies. Adaptive Computing Machines that utilize Adaptable parallel-series technology on the blade, component, IC level benefit greatly when processing data directly or by prefetching data as an embedded application I/O switch capable of routing results between Adaptable parallel-series nodes dynamically. Embedding processing code into the Adaptable parallel-series nodes can range from Operating System to database or application compute kernels which are compute kernels combined with embedded application code that can be static or dynamically generated from Agentic Ai, compression algorithms to any kind of processing algorithm that can benefit from intelligently prefetching and preprocessing data locally by a Adaptable parallel-series node rather than flooding the bus or memory to filter results. A sophisticated scheduler that utilizes machine learning and Artificial Intelligence governs the Adaptive Computing Machine to ensure that the most powerful configurations are employed from learning what the most effective combinations to process data are. Harnessing internal analytics the Adaptive Computing Machine learns how to dynamically configure itself to maximize performance while operating in a cost effective energy efficient manner. Employing FPGAs along with low watt processing DSP SoCs and other low watt technologies the Adaptive Computing machine dynamically configures itself by finding the most efficient manner to process data while managing heat, energy while conserving resources. Adaptable parallel-series DPU boards, Nodes, and cores can optionally employ any kind of I/O (InfiniBand, Fibre Channel, USB, PLX and similar technologies that have PCIe bus act like a TCP/IP network, PCIe over fiber in various topologies such as Bus, Star, Tree (Planar, Hierarchical), Fat Tree, Crossbar, Ring, Multistage Logarithmic Networks (such as Omega, Butterfly, Benes, Banyan), Hypercube, Torus, Mesh, and Hybrid fabrics that are a combination thereof (blocking and non-blocking) . . . even Wi-Fi and Cellular networks. Adaptable parallel-series technology allows for point to point interconnect such as Torus topologies as well as switched fabrics such as Mesh and Hybrid Mesh because it allow for multiple adapters to connect directly to other Adaptable parallel-series nodes be it boards, components or actual ICs and to a switched Fiber base fabric at the same time. The Adaptive Computing Machine architecture technology can scale from a SoC or low watt Chip comprising of numerous Adaptable parallel-series nodes to an entire HPC datacenter.

FIG. 2 displays Rack Manager 210 or a Lights-out Management (LOM) unit can also implement Rack Scale Architecture (RSA) is shared amongst a one or more of Adaptable parallel-series DPU boards of which portions of hub BMC chipsets are present in Adaptable parallel-series DPU boards 230 in the present embodiment described in FIG. 2. Each of first and second Adaptable parallel-series DPU boards 230 includes a first optional local onboard storage 270 for the Adaptable parallel-series DPU board's operating system usage and is part of the Adaptable parallel-series DPU board, node or device. An optional onboard Adaptable parallel-series DPU board (preferably SSD not shown) storage 270 respectively (not shown in FIG. 1) are employed to house the Adaptable parallel-series DPU boards local operating systems. These Adaptable parallel-series DPU boards'230 capable of delivering data directly local storage drives 270 bypassing the CPU 250 are displayed as part of the pooled Adaptable parallel-series devices FIG. 2. First and second optional onboard storages which reside on the physical Adaptable parallel-series board/device (not shown) function as extra general purpose local data storage hard drives and are capable of local RAID (Redundant Array of Independent Disks) storage. Adaptable parallel-series Agentic DPUs 230 can be directly connected to each other Agentic Adaptable parallel-series 220 optionally with fabric switches, bridges, routers and or channel adapters that optionally can harness controllers that utilize embedded Adaptable parallel-series DPU technology, and the one or more of Adaptable parallel-series DPU boards 230 and Rack Manager Hub 210 can function together. The Adaptive Computing Machine configurations can range from small consumer based devices to HPC Computers that utilize sophisticated storage, high speed RDMA and DMA based I/O with Unified-Memory units and so on.

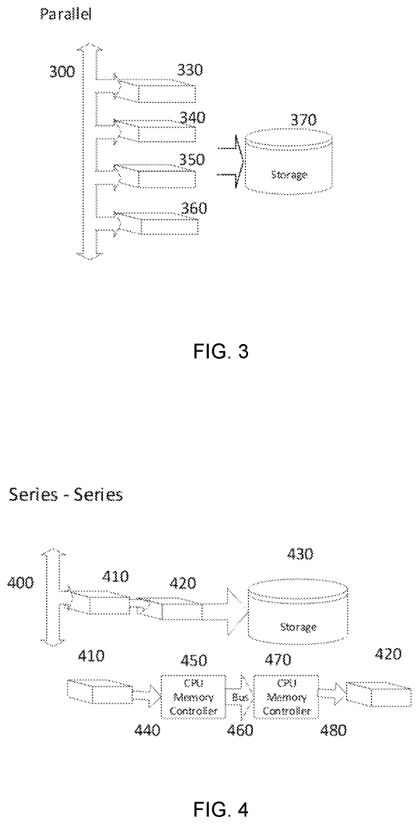

FIG. 3 is a block diagram of an exemplary detailing the flexibility of parallel configurations of Adaptable parallel-series nodes. Adaptable parallel-series nodes are now expanded in FIG. 3 nodes 330 and 340, and nodes 350, and 360 are connected to bus 300 in strictly parallel mode. These Adaptable parallel-series nodes operating in just parallel mode can span node types from cores in an IC to Components of a computer board to Rack Servers in Datacenters. In strictly parallel mode they have the capability of doing parallel processing and take a more traditional mode of operation which includes the CPU and System memory to process data before going to another node. However they have the capability of being able to also harness the Series connection of having accelerated nodes that include memory and CPU in some form on both sides of connection to be able to process the data internally and send the result set from memory of first component to the memory of the second component. The Series connection will go into more detail in FIG. 4. Adaptable parallel-series nodes be they ICs, components like individual SSDs. 330, 340, 350, and 360 can either reside in or send the results when finished to storages arrays 370. They could also represent data access from Memory or networking which can be accessed either through the common bus 300, can also be a slot on the board intended for an optional high performance Storage controller.

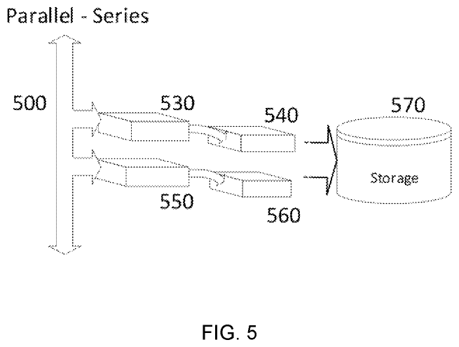

FIG. 4 is a diagram of another exemplary detailing a Series configuration of components which is the core of the technology. First and third Adaptable parallel-series where boards 410 and 420 are arranged in a series configuration connected by a bus or network for nodes that can reside on an IC, a board or a server. This arrangement between board 410 and 420 allows for embedded application in the nodes able to interact with acceleration computer kernels. Accelerated nodes can be used to prefetch metadata or data from the system including from other Adaptable parallel-series nodes or devices regardless of their mode of operation will now be augmented by Agentic AI. Netezza S-blade technology is utilized in preferably nodes controllers with CPU, Memory and a form of acceleration via an FPGA, ASIC, or even a form of flash that is as fast as SRAM memory which research and development are quickly closing the gap on, that embeds application code to be accessed by the compute kernel (referred to as Application Compute Kernel) controllers to prefetch and process metadata or data locally. The objective is to locate Application code in the node preferably in some form embedded into the controller where memory and CPU or microprocessors are located shown in 450 and 470. In FIG. 4 controllers 450 and 470 belonging to nodes 410 and 420 comprise of CPU and memory. Embedded application code in controller 450 belonging to node 410 processes data and transfers it to its associated memory node 470 over a bus 460, regardless of whether the communication is local or remote. Currently there are numerous industry names that utilize a Series direct memory to memory connection over a bus of two nodes on the component level such as Velocity Architecture, GPUDirect, Peer-to-Peer (P2P) Memory Access to name a few and (Compute Express Link) CXL, (Universal Chiplet Interconnect Express) UCIe, and AMD Infinity Fabric on the IC level and the list goes on and on all can be attributed to Adaptable parallel-series cluster technology. At their core a Series connection is strictly between one or more accelerated components that directly sends data across a bus, network or Fabric be it on an IC, component on a board or a server. In theory what kind of nodes they are and their functionality is abstracted from the type of connection between them. The novelty of this disclosure is that this Adaptable parallel-series shown in FIG. 5 utilizes Agentic AI processing so that able to write its own code, test it and then load it dynamically into the controllers, as if it's a true Reasoning Machine. Sophisticated Analytics based on logs kept in a scheduling system's database which is able to review and improve on performance by using AI to manage performance. In FIG. 4 Accelerated nodes 410 and 420 could be attached to a common bus 400 but it's not mandatory. It is not mandatory that every node in the system be it CPU core, an IC, or component on a board is capable of a Series connection I single component or node can do parallel-series with itself and nothing else in the system. In FIG. 4 there is a common bus 400 which also shows nodes 410 and 420 connected in Series. It just so happens this arrangement currently exists where GPUs utilize BiPassIO and PCIe Bifurcation that not only creates a GPUDirect capability by having a slot on the GPU for the SSD while also connected to the PCIe common bus. BiPassIO is another technology that bypasses the need for the CPU and is likened to GPUDirect. When a full Agentic system is combined with these gaming cards that are capable of BiPassIO and PCIe Bifurcation gaming kernels, API, frameworks can be dynamically located in or near the controllers 450 and 470 enhancing performance. Though both nodes 410 and 420 contain their own memory and CPU or microprocessors in controllers 450 and 470 that can represent cores of an IC, two SSDs, or a mixed arrangement of components such as a SSD 410 to GPU 420. There are new technologies on the market such as GPU gaming cards that have a direct PCIe slot for an SSD directly on them. Others GPU cards have the PCIe Both 410 and 420 have embedded application code that is accessed by the nodes form of acceleration such as an FPGA, eFPGA (embedded FPGA), Adaptive SoCs/MPSoCs, Structured ASICS to name a few that allow for processing data locally in the controllers of the Accelerated nodes 410 and 420. Eventually when a form of SSD that approaches the speed of RAM. Experimental “PoX” (Phase-change Oxide) memory technology from Fudan China, advanced MRAM (Magnetoresistive RAM), PCD (Phase Change Memory) or 3D XPoint which can approach speeds of traditional DRAM and SRAM in but are not quite in production can fill the role of dynamically holding code inside or near a nodes controllers. Any form of application be it produced by an preferably local Agentic AI system or standard AI, Financial, Analytical whatever can be dynamically loaded and unloaded into the controllers. Metadata can be generated that catalogs exactly where data is located using various database hashing, cataloging techniques like zone mapping thus a whole world of high performance possibilities opened up for direct communication of exactly where data is located to be accessed amongst devices that resolved the Von Neumann bottleneck. Now that Agentic Ai augments that design further the possibilities for compute to mimic human thought that potentially astounding. When two Adaptable parallel-series nodes (410 and 420) are connected in series they can utilize compression algorithms and application-level optimizations to prefetch data from optional storage arrays. The system can then leverage an Agentic AI platform that integrates local, cloud-based, or hybrid access to various Large Language Model (LLM) models. This integrated system enables optimization of new code and scheduling for optimal performance, with the AI platform reviewing quality before loading the optimized code, resulting in significant performance gains. Employing streams like libraries can even improve performance by prefetching from continuous streams if possible. The system can be capable of having storage 430 as the target of the processing where the results will reside. A new form of Database Appliance technology in conjunction with Apache Spark will eventually be able to dynamically stage processing steps on numerous Adaptable parallel-series devices and to maximize performance of set logic operations.

FIG. 5 is a diagram detailing the flexibility Adaptable parallel-series nodes 530, 550 are shown operating in parallel connected and are capable of being connected to common bus 500 are a parallel. Connected in Series to the nodes that are initially connected to the bus in parallel are 540 sequentially to 530 in parallel with 560 sequentially to 550. The two initial parallel nodes 530 and 550 form a group that is connected in Series to the next set of parallel nodes 540 and 560. Groups of nodes in parallel can continually be sequentially linked to accomplish CPU bypass because each accelerated Adaptable parallel-series node has its own CPU and memory to manage the connections. Therefore the processing power of FIG. 3 and FIG. 4 can be combined for processing power as shown in FIG. 5 for a full Adaptable Agentic Parallel-Series cluster. As illustrated in FIG. 4, this arrangement allows that many stages and types of data to be prefetching can be employed by chaining Adaptable parallel-series nodes or devices one after the other. Therefore drives that are naturally in parallel 530, 550 can have groups of sequential drives 530 and 560 follow them to conduct the next stage of processing. A traditional architecture can do this when its CPU and system memory manage the data flow, an Adaptable parallel-series accomplishes this with CPU bypass where the data is directly sequentially sent to the drives in a Series configuration detailed in FIG. 4. Some of the possible physical arrangements that the Adaptive Computing Machine Adaptable parallel-series boards can have. Adaptable parallel-series boards 530, 540, 550, and 560 have many options for accessing optional storage. For example, optional storage can be connected to the common bus 500. In another example, Adaptable parallel-series nodes 530, 540, 550, and 560 can access the data via SerDes connections over the system bus. At some point the PCIe root complex technology switches that can function like a network bridge, routing data between multiple PCIe devices and the system's PCIe root complex (typically the CPU), utilizing serial lanes for point-to-point communication will be augmented with various technologies can potentially be combined with SerDes (Serializer/Deserializer sometimes referred as SERDES) technologies in the future could be implemented to enhance performance and scalability in high-speed data center. This type of technology is an extension of PLX technology that was purchased by Broadcom and has spawn ExpressLane the successor to older PLX technology, along with similar systems such as Microchip SwitchTec, GigaIO and PCIe Bifurcation lane splitting. CXL technologies are built on top of PCIe, is increasingly incorporating SerDes technologies to support high-speed interconnects for memory and accelerator. This augmented PCIe could also have compression, decompression, hashing, and encryption not to mention other application code including Agentic AI dynamically generated code to aid in facilitating a system wide zone map that catalogs data. These technologies can be implemented as adapter type ASICS or even as software implementations with embedded Adaptable parallel-series that combines microcontrollers, microprocessors, SoCs, DSPs and FPGAs as a storage, memory or network controller or combination and or consolidation thereof. Storage fabrics logically exist as combinations of hardware and Software Defined Networks. Transceiver technology has gotten so advanced with the commercialization of Silicon Photonics, lasers, and IC interconnect circuitry can soon all reside inside the connector.

FIG. 3 to 5 show examples of the logical representations nodes are capable of in the diagrams can represent numerous parallel series configuration and combinations thereof to facilitate various traditional hub and spoke and switched fabric mesh 2D and 3D sophisticated hybrid topologies that allow for connections to a network device and another Adaptable parallel-series node or board directly. Any combination of chip technologies mentioned or emerging technologies can be combined on either side of the Adaptable parallel-series board/node/core be it the processing or embedded applications accelerator controller side. Adaptable parallel-series nodes can be comprised of many Adaptable parallel-series nodes and many Adaptable parallel-series cores can reside on a chip with sophisticated network interconnect topology. Adaptable parallel-series Agentic devices can be physically provisioned with logical bus controller host and target bus logic that can be combined and consolidated with other high performance interconnect technologies like the various InfiniBand over Ethernet implementations to reduce cost and are optional allowing for greater ease of manufacturing as well as scalability. Mezzanine cards can be developed as daughter cards effectively capable of turning a typical blade board into an Adaptable parallel-series Agentic DPU daughter board. Adaptable parallel-series Agentic technology can mount other Adaptable parallel-series devices via the disk controller side and can call the embedded code to process data as if it were a file system via a device driver; however there are numerous ways a Adaptable parallel-series devices can access data from another. Similar to comparable technologies such as MPI, DMA and RDMA, that employ Thunderbolt, InfiniBand, iWARP, RoCE, iSER/NVMeF, Nonvolatile Memory Express (NVMe) and (NVMe) over Fabrics (NVMeOF), NUMALink, InfiniBand and its derivatives (such as HDR Quantum InfiniBand, Omni-Path and so on), PLX technologies types, Thunderbolt, Ethernet over Fiber and any of the emerging Fiber Fabric technologies in any combination or consolidation thereof where suited, a Adaptable parallel-series DPU I/O chip can be developed with complex toroid and mesh interconnect that would contain all I/O algorithms and processing capabilities to manage I/O processing to the common bus and to another Adaptable parallel-series DPU card. Like a SoC an Adaptable parallel-series Agentic DPU SOC Chip would be divided into Nodes similar to a multicore CPU chip or be in separate defined sections of the SOC that have various functions like acceleration, I/O fabric to name a few. Each node would be a self-contained Adaptable parallel-series Agentic DPU Cores that could be assigned to I/O ports to be utilized in series-parallel manner. Optionally there can be a slot provided on Adaptable parallel-series node devices 530, 540, 550, and 560 for enabling a physical insertion to utilize third party Memory, Network or Storage controllers as an optional device. Adaptable parallel-series devices 530, 540, 550, and 560 can be Agentic or regular Adaptable parallel-series compute devices attached in a serial configuration can be arranged for prefetching by having code generated by AI Agents with sophisticated plan orchestration that can use machine or deep learning to produce, review, compile, test and install into any controller dynamically. By embedding application code on each level, it can allow the processing of many stages of prefetching. Adaptable parallel-series devices 530, 540, 550, and 560 attached in a parallel configuration can distribute processing across them simultaneously in a distributed manner but can also work with traditional computer board hardware. Thus, according to the present disclosure, customized combinations can be implemented to tune the Adaptive Computing Machine appliance to any application, whereas currently available computer appliances are not as flexible.

Today there is a real push to consolidate technology to cut costs and having fabric implemented to work over Ethernet, therefore the logical representation of the fabric adapters can be implemented in hardware, software or a combination of both. For example if RoCe is deployed over a fiber Ethernet backbone fabric it will be able to call MPI and RDMA and InfiniBand or similar APIs utilizing these logical adapter representations while also functioning as a standard networking implementation. It is this bidirectional ability for the Adaptable parallel-series devices to be able to connect to the common bus to be able to provide simultaneous host and target access to other Adaptable parallel-series device that is at the heart of the ability to make parallel and series connections. The Adaptive Computing Machine configuration shown is a representation of Adaptable parallel-series Agentic technology that is used throughout the entire system that could comprise of numerous storage, In-Memory and network subnet topologies. Having the ability to connect to the common bus in a bidirectional fashion with logical to neighboring Adaptable parallel-series board affords the Adaptive computing machine to make point to point or switched connections with its neighbors or to connect to various other resources to form sophisticated 2D and 3D network interconnect hybrid topologies with various networking and fabrics. It is common that controllers like SmartNICs have multiple adapter technologies combined that can implement storage fabric technologies such as InfiniBand over Ethernet can be added to have multiple bidirectional connections to network devices and to other card to implement sophisticated 2D and 3D network interconnect topologies. It is meant to show that not only several bidirectional bus connections can be established but also represents the logical usage meaning that each adapter could represent several adapters for various reasons. There are many available competing bus adapter technologies that can be combined and or consolidated, thus the modular design of Adaptable parallel-series DPU technology allows for older technologies to be upgraded while maintaining the existing hardware. Adaptable parallel-series node shown in FIG. 4 can utilize various types of adapter and networking technologies optionally employ any kind of I/O (InfiniBand, Fibre Channel, USB, PLX, PCIe over fiber, etc.) in various topologies such as Bus, Star, Tree (Planar, Hierarchical), Fat Tree, Crossbar, Ring, Multistage Interconnection Networks (MINs) (such as Omega, Butterfly, Clos, Benes, Banyan, etc.), Hypercube, Torus, Mesh, and Hybrid fabrics that are a combination thereof (blocking and non-blocking) . . . even Wi-Fi and Cellular networks. The entire Adaptive Computing Machine enclosure of Adaptable parallel-series DPU board 530 has the ability to be connected to common bus 500, with its neighboring Adaptable parallel-series DPU 550 which is appropriately assigned the master board in this instance, or other target Adaptable parallel-series nodes 550, and 560 as shown in the previous FIG. 3-5 are connected to 530 and 550 in series of which 530 and 550 are in parallel connected to the bus. Rather than having one exclusive bus technology, Adaptable parallel-series Agentic nodes and devices can accommodate several fabric I/O bus technologies that can be employed over high performance Ethernet such as Fibre over Ethernet (FCoE), Fibre Channel, USB, PLX, RoCe, iWARP, PCIe over fiber, etc. in any combination or consolidation in various topologies such as Bus, Star, Tree (Planar, Hierarchical), Fat Tree, Crossbar, Ring, Multistage Logarithmic Networks (such as Omega, Butterfly, Benes, Banyan), Hypercube, Torus, Mesh, and Hybrid fabrics that are a combination thereof. HBA and TCA are meant to facilitate bidirectional flow that can be a logical representation to represent software or hardware implementation instead of an actual hardware depending on the type of fabric used to facilitate its use seamlessly over fiber Ethernet. Traditional InfiniBand can coexist with implementations that are consolidated to work in a bidirectional fashion over Ethernet such as Fibre over Ethernet (FCoE), Fibre Channel, USB, PLX, RoCe, iWARP, PCIe over fiber, etc. Adaptable parallel-series devices can even act as sophisticated network or fabric devices depending on how many ports they are optionally equipped with. They can represent one or more daughter cards therein, which can be used as a storage array disk controller or other types of high performance specialized embedded controllers. Adaptable parallel-series devices have the ability to simultaneously act as In-Memory, Networking and Storage application embedded accelerator allowing it to take on almost any role it the HPC system with complex fabric topologies that include any type of architecture including Rack Scale Architecture where sections of the rack are dedicated to pooled resources of similar functionality. Therefore in FIG. 7 adapters such as Ethernet, Fibre Channel (FC), and InfiniBand (IB) and others mentioned are assumed in the connection of baseline components to which other auxiliary components which could be necessary to the overall functionality but are not baseline to a genetic modular approach have been omitted. For instance gaming machines that employ a split motherboard designs that have the PCH (Platform Controller Hub) chipset Southbridge I/O controller responsible for managing I/O operations and interfacing with various peripherals on a separate board typically might include a gigabit Ethernet controller for handling network connectivity for the console but also will include various chips such as differential comparator, likely used for signal processing or voltage comparison tasks, adjustable low dropout linear regulator, which helps manage power distribution on the board, Class AB audio amplifier, responsible for audio output processing, synchronous step-down converters with LDO (Low-Dropout Regulator), which help manage power efficiency and voltage regulation, a sound transducer and a video encoder/decoder HDMI IC connected to the HDMI port critical for proper display output all of which have not been included in the diagram 7 and 8 showing the Hub board. As for the boot sequence Southbridge I/O board simultaneously verifies peripheral connectivity (storage, HDMI, USB, and network interfaces) and coordinates with the main board. Then Southbridge board independently initializes its I/O controllers (e.g., Ethernet, audio codecs, and HDMI retime. Both boards synchronize via the PCIe interconnect to confirm hardware readiness confirms storage health and peripheral functionality and kernel performs cross-checks between boards which then does a handoff occurs to the gaming Dashboard. Though not all the auxiliary have not be shown which enhance the overall functionality they are more specific to a gaming machine rather than to a rack mounted server implementation. Thus the baseline chips are shown to outline the base functionality shown in the various diagrams.

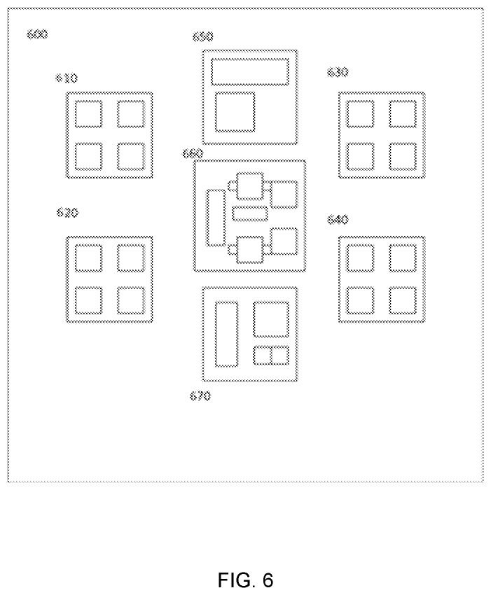

FIG. 6 is a representation of an Adaptable parallel-series SOC 600 that include Hub IC Chiplet 660 in the center that functions just like PCH chip (Platform Controller Hub) that handles all Peripheral communications and internal bus controller fabric communications capable of parallel-series I/O serializer-deserializer (SERDES or SerDes) logic resides on the Hub I/O die capable of DDR memory controllers, smart cache coherency, 100s PCIe SerDes lanes, SATA disk controllers and CXL connectivity, Global Memory Interface (GMI), secure memory encryption, and system management. However its enhanced functionality is augmented by the presence of an NPU (Neural Processing Unit), LPU (Language Processing Unit) or any of the other AI type processor chip technologies mentioned, Chiplet 650 and offloading processor acceleration Chiplet 670 technologies that comprise of adaptable offloading processor components such as Field Programmable Gate Array (FPGA) or similar technologies including Digital Signal Processor (DSP), Graphics Processing Unit (GPU), Application-Specific Integrated Circuit (ASIC), and Artificial Intelligence (AI). The other Chiplets 610, 620, 630, 640 represent CPU multicore units that operate in an Adaptable parallel-series fashion and can have embedded application Agentic AI code that assists in producing, compiling and loading into the acceleration units of the chip or assisting in performing dynamic code into controllers or other sections of other components in the system. These CPU Chiplets can employ energy efficient power schemes or designs ranging from the ARM big. LITTLE approach of either Clustered switching approach of having data passed through the common L2 cache, the active core cluster is powered off or having activated Cache Coherent Interconnect (CCI). CPU migration via the in-kernel switcher (IKS) involves coupling a ‘big’ core with a ‘LITTLE’ core with many identical pairs in one chip. Each coupled pair operates as one CPU unit or a so-termed virtual core, and only one actual core is running at a time. The ‘big’ core is used when the demand is high and the ‘LITTLE’ core is employed when demand is low. Nvidia created something similar to this with the low-power ‘companion core’ in their Tegra 3 SOC. Integrating the power management with Agentic AI to maximize the efficiency of the use of the CPU cores so that either selectively fully powering portions of the chiplet or using a subset of Chiplets 610, 620, 630, 640 can be employed as well as using the big. LITTLE approach on some of all of the Chiplets 610,620,630,640.

FIG. 7 is an electrical schematic block diagram of an Adaptive Computing Machine first system 1 according to the present disclosure of a hub board 720 and an exemplary any number of Adaptable parallel-series nodes, devices and board such as first and second Adaptable parallel-series boards 730 and 740 showing the main components and their configurations. Adaptive Computing Machine System 1 can include including but not limited to Intel®, AMD®, ARM® chips, RISC®, SPARC® and IBM® or any one of their competitors or adopters etc. and including emerging chip technologies. Depending on the design usage, implementation and chips technology used it is feasible to use or employ a KVM on the main board as a maintenance option. In server rooms there are times when blades need to have individual keyboard, mouse and monitor access. Whether integrated with other chips or components in the Adaptable parallel-series nodes, devices and board the option of having individual KVM maintenance access is not unreasonable. Adaptable parallel-series boards/devices 730 and 740 shown functioning as s DPU device can include any number of existing CPU technologies including SoC (System-on-Chip) types of processor chips 7300 and 7400. For exemplary purposes, it is described herewith that Adaptive Computing Machine system 1 has Adaptable parallel-series DPU board 40 and includes currently commercially used Intel/AMD/RISC-V/ARM/or some company specific technology such as Apple M and A line of processor chips as well as Snapdragon X Series and other competitors. However, the type of CPU or processor is not limited thereto and computer system 1 can employ various other types of CPU's or processors. The Adaptive Computing Machine can employ FPGA, DSP, GPU, ASICs, AI, Neural Processors and even Quantum Computing type accelerator devices or chips 7309 and 7409 to embed an application and whatever kernel functionality to assist with prefetching and processing algorithms in the Intelligent embedded controller or can be used by the processing side of the board for offloading complex application processing algorithms. The Adaptive Computing machine can employ processors 7300 and 7400 that contain sections FPGA, DSP, GPU, ASICs, AI, Neural Processors units in the processors as well as a separate onboard, inboard, and off board fiber connections with appropriate optical photonic transceivers and can even be Adaptable parallel-series DPU chips that contain those elements capable of internal parallel and series processing. By sharing resources between the processing side and the intelligent disk controller side of the Adaptable parallel-series DPU board the Adaptive Computing Machine can dynamically switch or share roles to change its configuration to maximize performance while cutting overall costs.

The entire Adaptive Computing Machine enclosure of Adaptable parallel-series DPU board 740 shown in FIG. 7 can have a local storage 7420 for the purpose of housing an Operating system and local data cache or be connected to a storage unit 7325 or another Adaptable parallel-series device. Adaptable parallel-series board/device 740 in FIG. 7 can be an Agentic AI device connected to optional local storage and can use it to house its operating systems and such. The entire enclosure of Adaptable parallel-series Agentic DPU board 740 can have an optional local storage 7420 for the purpose of housing an Operating system. Adaptable parallel-series DPU board 740 can be connected to optional local storage and can use it as a memory.

FIG. 7 depicts an Adaptive Computing Agentic AI Machine system 1 shown generally includes two parts: a peripheral hub which can occur as a suite of devices for cluster management also shown here as a singular hub board 720 as the first part and a one or more of Adaptable parallel-series boards/devices that function as Agentic AI devices, such as first and second Adaptable parallel-series boards/devices/nodes 730 and 740, as the second part. Hub board 720 provides I/O controller hub 7202 which is shared with first and second Adaptable parallel-series boards/devices/nodes 730 and 740. I/O controller hub 7202 can be shared with additional Adaptable parallel-series boards/devices (not shown in FIG. 7) that are attached to common bus 710. Hub 7202 can also reside on a standard motherboard. As mentioned each heat intensive component can have its own board or all can reside on a traditional motherboard, its just a way of dealing with overheating by lowering the inductance of the system. I/O controller hub 7202 can interface with slower peripheral devices like keyboards, mouse, serial connector and video. I/O controller hub 7202 can also interface with an Ethernet device 7207 which can be a router, bridge, switch (not shown) depending on the complexity of the network and what layers it interfaces with, or a wireless interface or including any combination of existing network devices.

First and second Adaptable parallel-series boards/devices 730 and 740 shown in FIG. 7, in turn, provide CPU/. SOC processing units 7300 and 7400 separately of Adaptive Computing Machine system 1. Hub board 720 is connected to first and second Adaptable parallel-series boards/devices 730 and 740 via common bus 710. Common bus 710 is depicted as being physically connected to its component parts and is fully capable of hosting many types of fabrics simultaneously and is capable of bidirectional processing where potentially any Adaptable parallel-series node can be a source or a target for another node. Although only two Adaptable parallel-series boards/devices are depicted, Adaptive Computing Machine system 1 can include additional Adaptable parallel-series boards/devices or can exist in chip form such as the AMD EPYC chip which has a HUB chip and Adaptable parallel-series processors, which are similar to Adaptable parallel-series boards/devices 730 and 740 described herewith which includes Peripherals access and management through the HUB chip by design. Hub board 720 can be comprised of commercially available chipsets. A chipset is a set of one or more conventional integrated circuits that manage the data flow between the processor, memory and peripherals, thus controlling communications between a processor (CPU) and external devices. The traditional conventional term “Northbridge refers to communication links between a CPU to very high-speed devices such as RAM and graphics controllers. The conventional term “Southbridge” refers to communication links between a CPU and lower-speed peripheral buses. The aforementioned I/O controller hub 7202 is comprised of a conventional peripheral bridge type I/O controller chipset and is connected to a main network switch (not shown). I/O controller hub 7202 is directly connected to a super I/O 7214, which includes a SATA (Serial Advanced Technology Attachment) or any other popular such as Serial Attached SCSI (SAS) and Non-Volatile Memory Host Controller Interface Specification (NVMe) depending on the sophistication of the Rack Management System and its chipsets augmented with 7215 RMC IPMI SOC that utilizes Intelligent Platform Management Interface (IPMI) interface or equivalent, an IDE (Integrated or Interactive Development Environment), a parallel port (not shown), and a USB (Universal Serial Bus)(not shown). Controller hub 7202 is also connected to an external Ethernet 7207, and can be a router, bridge, switch (not shown) depending on the complexity of the network. Hub board 720 further includes a clock interface 7206 and a BIOS memory 7216 interface, Erasable Programmable Read Only Memory (EPROM). A KVM 7212 interface to the BMC 7305, 7405 and other vital chips on board/device 730, 740 functioning in a rack version of the technology via a SMBus which can be KVM-over IP switch can be attached to manage any node in the system. Concerning that the KVM can utilize many different options depending its sophistication ranging from a RS-232 to a full management device over an IP switch the placement of the KVM in the circuit depends on its sophistication. Hub board 720 is a peripheral hub board sharing I/O controller hub 7202 with first and second Adaptable parallel-series boards/devices 730 and 740 electrically and in the current embodiment is physically connected thereto.

Hub board 720 displayed in FIG. 7 is also optionally coupled to a Channel Adapter for a connection with common bus 710, however can as an option exist as part of a traditional motherboard. Hub board 720 optionally supports a variety of baseboard management technologies from a simple hub connected directly to the common bus 710 if something similar to a full Rack Scale Architecture which usually employs IPMI on a separate SMBus and Ethernet connection to the rest of the system. Hub board 720 is physically and electrically coupled to common bus 710 by conventional board connectors. In addition, common bus 710 physically and electrically connects first and second Adaptable parallel-series boards/devices 730 and 740 to hub board 720. Common bus 710 which can be of a conventional Intel type includes conventional extended bus technologies, such as SATA III, SAS, Thunderbolt, PLX Technology ExpressFabric (Broadcom), PCI Express, Fiber Fabric Hub. I/O controller hub 7202 functions as a traditional Southbridge type chipset managing peripheral devices. Ethernet device 7207 provides a network connection to first Adaptable parallel-series main system board/device 730 and second Adaptable parallel-series DPU board/device 740 via common bus 710 which can also be a fabric in which many technologies are employed. The industry is striving towards consolidating and combining technologies that provide RDMA type functionality over high performance server to server fabric connections that employ Ethernet devices.

First and second Adaptable parallel-series boards/devices/nodes/ICs 730 and 740 are processing units for computer system 1 in FIG. 7. Thus, in some embodiments, hub board 20 can be configured with or without a CPU and/or without a memory. In this exemplary embodiment stead, platform peripheral hub board 720 shares I/O controller hub 7202 with first and second Adaptable parallel-series boards/devices 730 and 740, which contain a CPU 7300 and 7400 respectively and memory. The modular design accounts for the Adaptable parallel-series Agentic AI machine to reside all on one motherboard or each component to have a separate board to make the overall machine more energy efficient and thus less likely to overheat. As depicted in FIG. 7, first and second Adaptable parallel-series boards/devices 730 and 740 are configured optionally utilizes Intelligent Platform Management Interface (IPMI) or a Rack Scale Architecture RCM (Rack Manager Controllers) SOC chips equivalent which makes use of onboard BMC chipsets 7305 and 7405 respectively and interfaces via common bus 710 which includes the service bus uses I/O controller hub 7202 and BMC 7215 and possibly KVM 7212, which resides on hub board 720 that can act as an Agentic AI Rack Manager device. At least one of the Adaptable parallel-series boards 730 is configured as a master node and can have another HA failover configuration with another Adaptable parallel-series board/device which can be dynamic especially if running bare metal.

Adaptable parallel-series boards/devices 730 and 740 are depicted in FIG. 7 can have different components, configurations and connections in alternative embodiments. In the exemplary depicted configuration of FIG. 7, first Adaptable parallel-series device configured as system board/device 730 functions as a master node and second Adaptable parallel-series DPU board 740 functions as a slave node but is not mandatory in that order. First Adaptable parallel-series DPU board 730 includes first CPU 7300 that is connected to a one or more of board components: a first clock 7306, a first memory 7308, an accelerator 7309, and first BIOS 7304. First memory 7308 is coupled to first CPU 7300 via a high speed memory bus 7310. Depending on the type of CPU employed one or more of the components can reside on first CPU 7300 chip. First Adaptable parallel-series main board/device 730 is comprised in one embodiment of the disclosure of four basic forms of bus controllers/adapters. Each controller/adapter employs an extended I/O bus technology such as a SATA, SAS, NVMe, Thunderbolt Interface, and PCI Express, PLX technology (now Broadcom) and other similar technologies just to name a few of the myriad of networking fabric technologies available, including high performance storage networks etc. The controllers/adapters are configured as known in the art to define the base controllers that are employed because there are commercially available bidirectional chipsets. In the present disclosure, each bus adapter is able to connect to either common bus 10 or another Adaptable parallel-series board/device, as desired.

As depicted in the embodiment of FIG. 7, first Adaptable parallel-series board 730 functions as a processing unit of hub board 720. First Adaptable parallel-series board/device 730 is connected to I/O controller hub 7202 and to a main network card/switch/bridge/router including Ethernet device 7207 and can interface with Adaptable parallel-series boards/devices 730 and 740. First Adaptable parallel-series board/device 730 is connected to the hub board 720 via common bus 710 and a host connector 732 which provides power and physical support. with Adaptable parallel-series boards/devices 730 and 740 also have the capacity to support KVM peripherals for maintenance purposes even if redundant with the HUB board 720. Second Adaptable parallel-series DPU board 740 includes a second CPU 7400 that is connected to a second clock 7406, a second memory 7408 via a second memory bus 7410, an accelerator 7409, and a second BIOS 7404. Accelerator 7409 can be a myriad of SOC technologies mentioned herein ranging from offloading processors to NPU, APU, QPU, LPU . . . or customized acceleration device suited to a specific task or augmented by an FPGA type technology. Adaptable parallel-series Agentic AI host and target bus adapter depicted are optional depending how they are configured and how Agentic AI is employed on them. Components shown in FIG. 7 are meant to detail the functionality of the Adaptable parallel-series board/device not the exact placement or denomination. For instance the location of and type the components that comprise the Accelerator 7309 and 7409 can reside anywhere on the board are optional and can be modular in multiple locations. For instance if the Adaptable parallel-series board/device is populated to have a host and controller side that share resources though a high performance bus, components such as DRAM, FPGA, DSP, ASICs, SSD, Memristors technologies, and CPU can reside in multiple denominations on both sides without diminishing the overall functionality or novelty of the disclosure.

In FIG. 7 is an optional host bus controller that is configured to connect to a second optional local storage 7420, and functions as a host in conjunction with an operating system running in a slave node role. Adaptable parallel-series devices configured to support the controller technology applied to common bus 710, including conventional SATA, SAS, NVMe, PLX technology, PCIe, and/or Thunderbolt or emerging InfiniBand like fabrics. Depicted in the embodiment of FIG. 7 is configured to support the controller technology applied to the common bus 710 including SATA, PLX technology ExpressFabric, PCIe, Thunderbolt interface and/or Storage Network fabrics. The second optional local storage 7420 can be an SSD (Solid State DriveEach of Adaptable parallel-series boards 730 and 740 is fully capable of hosting the same or different operating system if a virtual Operating System is employed. Such conventional operating systems can include, for example, Microsoft Windows, UNIX or Linux.

First and second optional local storages 7320 and 7420 depicted in the embodiment of FIG. 7 can have an additional SSD and a RAID mirror respectively. For example, second optional local storage 7420 can have a conventional RAID setup within the SSD structure. Also, first and second optional local storages 7320 and 7420 can each be comprised of more than one SSD. For example, second optional storage 7420 can have a RAID setup with two SSDs or other various forms of RAID technology. First and second Adaptable parallel-series DPU boards 730 and 740 function as a processing unit of the hub board 720, and they are connected to and share the I/O controller hub 7202 and the main network switch (not shown) residing on hub board 720. First and second Adaptable parallel-series boards 730 and 740 do not require an external network switch to communicate because they are directly connected to the shared main network device that resides on hub board 720 by common bus 710. That is because communication between hub board 720 and Adaptable parallel-series boards/devices 730 and 740 can be facilitated by a unique type of Adaptable parallel-series device ID number similar to PLX technology. Thus, first and second Adaptable parallel-series DPU boards 730 and 740 can have a network connection with Ethernet device 207 that resides on hub board 720 via such communication.

Thus, according to the present disclosure, Adaptive Computing Machine system 1 featured in the embodiment of FIG. 7 can be established without external network switches depending on the I/O technology used such as PLX technology or Thunderbolt. It can also interface with Model Context Protocol (MCP) servers that can be locally installed or remote that act as open protocol bridges that securely connect to services like databases, file servers, APIs and toolsets as well as MCP servers connecting to it. This results in a spatially compact computer system that can have a relatively low price. Common bus 710 is connected to first Adaptable parallel-series board/device 730 via host connector 732. Each of first and second Adaptable parallel-series boards 730 and 740 can contain an internal software type of network switch to interface with other Adaptable parallel-series boards. Each of the one or more of Adaptable parallel-series DPU boards 730 and 740 includes, for example an NVMe disk controller that connects to a conventional internal Solid State Drive that houses the operating system of Adaptable parallel-series Boards/devices/nodes 30 and 40. Optional local storages 7320 and 7420, connected to first and second Adaptable parallel-series DPU boards 730 and 740, in different embodiments can be a location for the Operating System, for a cache memory and for temporary processing and/or swap space. First Adaptable parallel-series DPU board 730 and second Adaptable parallel-series DPU board 740 is configured as a small non HPC but doesn't preclude it so that conventional Southbridge peripheral interface type chipsets are not required. However if Rack Scale Architecture is employed for a HPC implementation of an Adaptable Computing Machine that utilizes Adaptable parallel-series DPU technology a IPMI on a separate SMBus including BMC 7215 would be an appropriate choice for cluster management.

The present Adaptive Computing Machine disclosure as configured as described above includes first Adaptable parallel-series DPU board 730 and second Adaptable parallel-series DPU board 740 depicted in the embodiment of FIG. 7 that can be flexibly configured for parallel and/or series connections such that each board can function in various roles. Such roles include being a processing unit with pre-filters that is configured or arranged as processing units which can be tuned for the needs of one application and then retuned or reconfigured for others. This is distinguished from a conventional blade server that is configured to have only one physical board with rigid, fixed pin connectors for daughter boards such that CPUs can only go into designated slots.

Each Adaptable parallel-series boards 730 and 740 includes a hub/target controller that is configured to be accessed by optional common bus 710 which has ability to contain full operating systems or act strictly as a traditional disk, memory or network controller. Each Adaptable parallel-series board 730 and 740 is modified from a standalone unit on the network by having included on it a high performance modern high performance type connector to connect to a common bus 710 hosted by the hub board 720. Each Adaptable parallel-series boards/devices 730 and 740 optionally can function as a standalone unit which is connected to a conventional network as a typical blade. Each Adaptable parallel-series board 730 and 740 has the option of having its own SSDs or part of a storage array. In the embodiment of FIG. 7, the SSD is connected to first and second Adaptable parallel-series boards 730 and 740 by a specialized internal high performance bus interconnect. Conventional bus connectors include, for example SAS or other current, commercially available high speed emerging controller technologies. This results in a physical configuration that has a relatively extremely small footprint. Optional local storages 7320 and 7420 function for their respective Adaptable parallel-series boards for local swap space of an operating system.

As noted, the present description of the present disclosure utilizes only two Adaptable parallel-series DPU boards, namely first and second Adaptable parallel-series DPU boards 370 and 740, each shown having only one CPU, but the present disclosure encompasses a one or more of more than two Adaptable parallel-series DPU boards that can each contain multiple CPUs, SSD, RAM, fabric adapters and Accelerator components and the descriptions above are to be construed as also encompassing more than two Adaptable parallel-series boards. Thus, according to the present disclosure, Adaptive Computing Machine system 1 diagramed in FIG. 7 can be virtualized to provide hub board 720 for sharing the peripheral I/O controller hub 7202 can be represented as a simple USB based device all the way to a full HPC Rack Scale Architecture, whereby first and second Adaptable parallel-series boards 730 and 740 are utilized for data processing but can be interpreted to represent a collection of nodes and are for diagramed to highlight the functionality and novelty of the disclosure. However to the underlying virtual machine software that links the systems together at the lowest level, the entire system can appear as if it is one computer system to the management systems. Virtual machine software or presentation layers enables more than one operating systems or facsimile similar to Microsoft WSL thereof to be installed on computer system 1.

Further modifications of the presently described embodiment include utilizing one or more Adaptable parallel-series boards with one or more of the adapter technologies which provide employ MPI, DMA, RDMA type functionality, and could use iWARP, RoCE, iSER/NVMeF, Nonvolatile Memory Express (NVMe) and (NVMe) over Fabrics (NVMeOF), NUMALink, InfiniBand and its derivatives (such as HDR Quantum InfiniBand, Omni-Path and so on), PLX technologies, Ethernet over Fiber, Non-Volatile Memory Host Controller Interface Specification (NVMHCIS) that can assist in acting as a IN-Memory, NUMALink, InfiniBand Storage technologies and their derivatives that include embedded SmartNICs based Optic Fiber based Network controllers including customized advanced versions listed or relevant and combination of elements thereof. Other existing InfiniBand and future Fiber Fabric technologies that offer InfiniBand type functionality without the actual implementation can be used and are represented by the depiction of logical adapters. Thus, depending on which type of fabric technology is utilized, the Adaptable parallel-series boards can be established with bare-metal or with virtualization software.

The SSDs in Adaptable parallel-series boards 730 and 740 in FIG. 7 can be used with a conventional operating system and/or swap space depending on how many SSDs are attached. Adaptive Computing Machine system 1 depicted in FIG. 7 further includes an optional GPU 770. Optional GPU 770 high performance graphics or vector processor and can be a bank of GPGPU that exist as a pooled resource that is connected to common bus 710 via a common bus or hybrid mesh switching fabric or both. The accelerator 7309 and 7409 which can be of any type mentioned within this document shown in FIG. 7 on Adaptable parallel-series DPU boards 730 and 740 respectively are capable optionally being configured as a network, memory or storage accelerator depending on how they are configured and can simultaneously coexist as one. Interconnect technologies are flourishing from the once dominant PCIe in the HPC realm to accommodate high bandwidths that were unthinkable just a few years ago and are topping out over 100 GBs. For instance accelerator 7309 on Adaptable parallel-series board 30 has interconnect buses 7312, 7313, 7322 . . . which can be PCIe, or high performance interconnect that can eventually be fiber based to couple the accelerator 7309 to memory, network or storage through HBA and TCA interconnect. The accelerator 7309 can have memory 7308, local SSD storage 7320, and even network devices and can be a separate card or it can share resources with the host side of the Adaptable parallel-series card or it can access both. Therefore network devices, memory 7308, and local storage 7320 can reside on both sides of the Adaptable parallel-series DPU host and controller or could be shared and can exist in multiple denominations. Interconnect 7310 represents a high performance multi-channel memory bus connecting the memory to the CPU 7300 capable of implementing accelerator memory interconnect fabric technologies similar to Open Coherent Accelerator Processor Interface (OpenCAPI), Cache Coherent Interconnect for Accelerators (CCIX) and GEN-Z, as well as proprietary memory fabrics.

A PCIe type slot or high performance interconnect slot on Adaptable parallel-series boards 730 and 740 in FIG. 7 can accommodate an advanced embedded application accelerator that shares resources with controller to access storage, network or memory or any combination of the thereof. In the present disclosure, Adaptable parallel-series DPU board 730 functions as a virtual master node that is fully capable of also being an internal domain server and network switch, depending on the type of server operating system that is installed and how it is configured. By having a dedicated virtual operating system on Adaptable parallel-series boards 730 and 740, each becomes a realized machine that doesn't have to share its physical resources with another the Adaptable parallel-series board as an option to a bare-metal implementation therefore can be optionally expanded. Open source virtual machine software can be modified so that it recognizes each of Adaptable parallel-series boards 730 and 740 in the virtualized Adaptive Computing Machine system 1 and can seamlessly assign Operating System resources to the other Adaptable parallel-series DPU boards as if they were regular Virtual Machines. It is possible to have the realized machines as part of the installed bios of the machine or installed in a similar manner as current virtual machine software is installed. Also, operating systems can be striped across many Adaptable parallel-series boards/devices with one IP address assigned to each one. The amount of flexibility that the Adaptable parallel-series boards'technology provides is achieved by the configuration of their respective operating systems and the physical arrangement of the Adaptable parallel-series boards in the system. Adaptable parallel-series boards achieve their flexibility entirely from how they are physically arranged in the system and how the operating system is applied to them. The software that achieves the Adaptable parallel-series board's flexibility employs a modified version of the Open Source Virtual Machine Software and is conventional and known in the art.

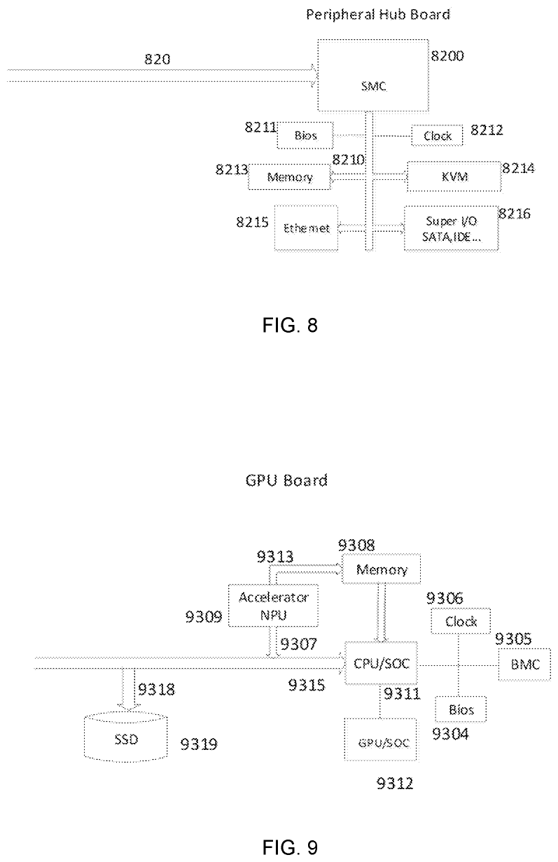

FIG. 8 represents a Peripheral Hub Board of a Gaming system or workstation that employs the split motherboard design to alleviate overheating by assisting air cooling. FIGS. 8-12 show the flexibility of the designs modularity. This functionality can reside on a single motherboard but has an advantage of being to operate more efficiently by lowering the impedance of the Adaptable parallel-series board/devices in the system. The Southbridge I/O controller SMC PCH chip 8200 shown resides on the Hub board and connects to the main gaming Adaptable Parallel-Series board through a PCIe connection. This arrangement will also work for workstations. This is a gaming, PC or small workstation alternative modular version of the design shown in FIG. 7 that was more appropriate for a rack server or blade system. An Accelerator such as 7309, 7409 can comprise of various components that can primarily include Field Programmable Gate Arrays, (FPGA) for the purpose of offloading or maximizing performance, that also can include Graphics Processing Units (GPU), General Purpose Computing on Graphics Processing Units (GPGPU), Tensile Processing Units (TPU), Accelerated Processing Units (APU), Central Processing Unit (CPU), Digital Signal Processing (DSP) resources, Application-Specific Integrated Circuits (ASICs), Very Large Scale Integrated circuits (VLSIs), Artificial Intelligence (AI) Processor, NNP (Neural Network Processor), Complex Programmable Logic Device (CPLD), Quantum Computing or a combination of elements thereof. The Accelerator can augmented by or assist various local devices such as any of memory RAM drives, Optical Network on a Chip (ONoC), Optical PCIe via Silicon Photonics, System on a Chip (SoC), Solid State Drive SSD, that employ MPI, DMA and RDMA, iWARP, RoCE, iSER/NVMeF, Nonvolatile Memory Express (NVMe) and (NVMe) over Fabrics (NVMeOF), NUMALink, InfiniBand and its derivatives (such as HDR Quantum InfiniBand, Omni-Path and so on), PLX technologies, NVLink, Ethernet over Fiber, Non-Volatile Memory Host Controller Interface Specification (NVMHCIS) that can assist in acting as a IN-Memory, NUMALink, InfiniBand Storage HBAs combined with network switching HCA/TCA switches and network devices or embedded SmartNICs based Optic Fiber based Network controllers including customized advanced versions listed or relevant and combination of elements thereof. It can communicate with various (Top of the Rack) devices that include Rack Managers, BMC, Management software suites and bridges, switches and routers.

FIG. 9 is Adaptable parallel-series GPU version of the Adaptable Parallel-Series Technology that can range from a gaming GPU all the way up to a HPC Tensor GPU targeted at AI and procuring Foundational Models such as LLM. FIG. 9 is a GPU version of a Adaptable Parallel-Series board/device that could that has its own NVMe SSD capable of GPUDirect or parallel-series processing having a Netezza Sblade embedded in the controller that comprises of usually ARM cortex CPU but could also RISC-V or any other proprietary CPU processor technology and various forms of Memory 9308 and an embedded application in the form of combination of ASIC or FPGA accelerated technology or both accessed by a compute kernel also known as an application compute kernel and or its own facsimile of an Operating System Kernel. It could have a sophisticated scheduler that uses Agentic AI to manage the machine using Analytics, Deep Learning and Machine Learning and include a specific NPU 9309 and or offloading processor or combination thereof. In FIG. 9 9311, and 9312 can be a single GPU or are GPU server boards, blades or individual GPU cards in a hybrid mesh as part of the common bus and or a GPU hybrid mesh fabric that could hold many more than shown. Adaptable parallel-series Agentic AI GPU can have the fully functional ability of acting like a mini computer with local Bios 9304 and clock 9306 and optional BMC 9305 capable of employing Adaptable parallel-series GPU Agentic AI technology to enrich itself by dynamically producing its own code to embed inside controllers or to run on the device or produce it for other devices in the system by function shipping to various components, devices or nodes.

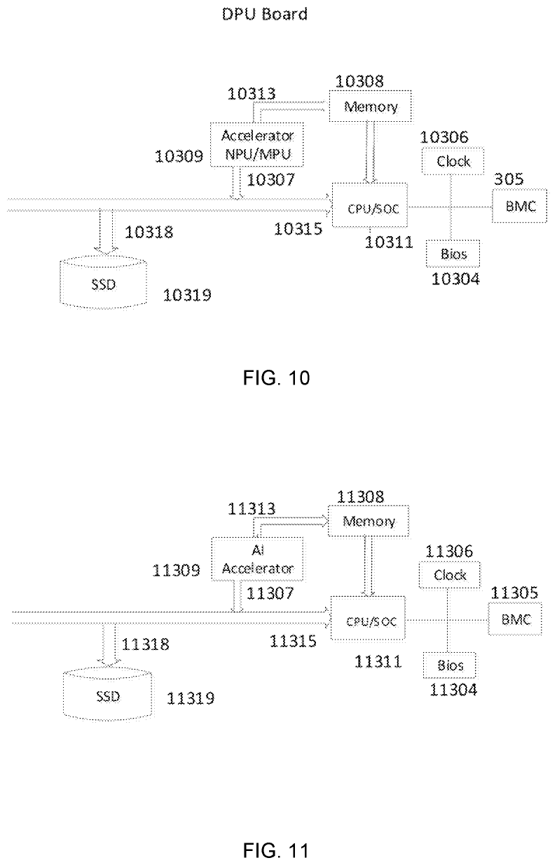

FIG. 10 is another incantation of the Adaptable parallel-series Agentic AI technology in DPU form. The DPU version of a Adaptable Parallel-Series board/device that could that has its own NVMe SSDs capable of GPUDirect or parallel-series processing having a Netezza Sblade embedded in the controller that comprises of usually ARM cortex CPU but could also RISC-V or any other proprietary CPU processor technology and various forms of Memory 10308 and an embedded application in the form of combination of ASIC or FPGA accelerated technologies or both accessed by a compute kernel also known as an application compute kernel and or its own facsimile of an Operating System Kernel. It could have a sophisticated scheduler that uses Agentic AI to manage the machine using Analytics, Deep Learning and Machine Learning and include a specific NPU, MPU, IPU, 10309 and or offloading processor or combination thereof. It is capable of playing multiple networking devices roles in the system. Adaptable parallel-series Agentic AI DPU can have the fully functional ability of acting like a mini computer with local Bios 31004 and clock 10306 and BMC 10305 capable of employing Adaptable parallel-series DPU Agentic AI technology to enrich itself by dynamically producing its own code to embed inside controllers or to run on the device or produce it for other devices in the system by function shipping to various components, devices or nodes.

FIG. 11 is another incantation of the Adaptable parallel-series Agentic AI technology in Storage unit form. The Storage version of a Adaptable Parallel-Series board/device that could that has its own NVMe SSDs capable of GPUDirect or parallel-series processing having a Netezza Sblade embedded in the controller that comprises of usually ARM cortex CPU but could also RISC-V or any other proprietary CPU processor technology and various forms of Memory 11308 and an embedded application in the form of combination of ASIC or FPGA accelerated technologies or both accessed by a compute kernel also known as an application compute kernel and or its own facsimile of an Operating System Kernel. It could have a sophisticated scheduler that uses Agentic AI to manage the machine using Analytics, Deep Learning and Machine Learning and include a specific NPU 11309 and or offloading processor or combination thereof. It is capable of playing multiple networking devices roles in the system. Adaptable parallel-series Agentic AI Storage can have the fully functional ability of acting like a mini computer with local Bios 11304 and clock 11306 and BMC 11305 capable of employing Adaptable parallel-series Storage Agentic AI technology to enrich itself by dynamically producing its own code to embed inside controllers or to run on the device or produce it for other devices in the system by function shipping to various components, devices or nodes.

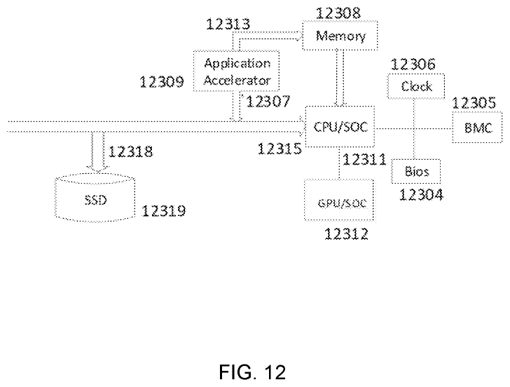

FIG. 12 is another incantation of the Adaptable parallel-series Agentic AI technology in generic or specific Application unit form. The Application version of a Adaptable Parallel-Series board/device that could that has its own NVMe SSDs capable of GPUDirect or parallel-series processing having a Netezza Sblade embedded in the controller that comprises of usually ARM cortex CPU but could also RISC-V or any other proprietary CPU processor technology and various forms of Memory 12308 and an embedded application in the form of combination of ASIC or FPGA accelerated technologies or both accessed by a compute kernel also known as an application compute kernel and or its own facsimile of an Operating System Kernel. It could have a sophisticated scheduler that uses Agentic AI to manage the machine using Analytics, Deep Learning and Machine Learning and include a specific NPU 12309 or specific customized offloading processor or combination thereof. It is capable of playing application roles in the system be it robotics, medical devices, AI HPC machines, weather forecasting, Financial, Payment Processing, IoT and wearables, a SOC IC or a SOC in a PDA (Personal Digital Assistant) forms of Adaptable parallel-series Agentic AI devices can have the fully functional ability of acting like a mini computer with local Bios 12304 and clock 12306 and optional BMC 12305 capable of employing Adaptable parallel-series devices Agentic AI technology to enrich itself by dynamically producing its own code to embed inside controllers or to run on the device or produce it for other devices in the system by function shipping to various components, devices or nodes.

One of the most apparent application specific uses of the Adaptable parallel-series Agentic AI technology would be the technology whist it was derived from being Databases and Database Appliances ranging from PostgreSQL incantations from Greenplum, Snowflake to Redshift, as well as related technologies such as Hadoop, Spark, and other NoSQL databases. Since the technology was derived by employing SSDs such NVMe being equipped with Netezza Sblade technology that include compression, encryption, and hashing for Zonemap implementation it only makes sense to extend the technology to where it came from. Having a functioning Sblade in the controllers of components and ICs able to employ the technology or facsimiles thereof opens a whole world when combined with a data storage application like a database or host processing server like Apache Spark or enhanced Spark technology like Databricks or Microsoft Synapse. Many such as Michael Stonebraker of MIT CSAIL have proposed a Database Operating System to replace the generic Linux system. Though many parts of Linux are not involved it supporting a database and provide use and entire replacement of the OS is not out of the question considering that Database Kernels have bypassed the OS when running what is known as raw meaning they write directly to disk volumes without filesystems managed by the OS. There are many other types of performance techniques such as direct I/O, Memory-Mapped I/O Libraries, to customized OS bypass technology to bypass the operating system's page cache and other Linux kernel performance starving management. CPU data caches have gotten large enough that in the recent past have been opted for over traditional In-Memory buffer caches. However now that Netezza Sblade technologies are not implemented in NVMe SSDs and have sophisticated controllers with local high end DRAM companies like Phison have extensive libraries to prefetch data from Zonemap metadata and using Bloom filters type techniques to anticipate what data is require by query engines that now can be embedded inside the controller performance gains can be realized through traditional database techniques like partitioning that offer a whole new world of performance gains. Embedding part of the Database kernel as part of a controller compute kernel offers even more gains when enhanced by Agentic AI capabilities. Not only can metadata of the job stream and runbook can fully be analyzed with machine learning and Deep learning algorithms but now query optimizers can have Agentic AI analytics further provide performance gains especially since most servers run batch jobs in a regular fashion. Database optimizers have been employing machine and deep learning for years but not to have Agentic AI agents review, analyze and update SQL and other database kernel code and compile it instead of running it as an interpreted code as some database appliances now do reveals a myriad of performance analytics to enhance SLA runtimes. Cloud and local onboard agents can search the web for new latest breaking technologies and attempt code them and eventually employ them in the actual database to enhance performance. Now that vector database technology is being employed in database tables as a searching mechanism GPUs are now being employed. It's only natural the marriage of Vector databases and its indexing to employ Adaptable parallel-series Agentic AI technology capable GPUs, IPUs, APUs, TPUs . . . and even QPU to enhance performance gains. It's only natural that the Adaptable parallel-series technology that has its roots in the Database Appliance Netezza that companies back in 2014 wrote off as no longer necessary and that offloading processors like FPGAs were obsolete now drives that market to performance gains assisted by Agentic AI.

The present Adaptive Computer Machine technology can be applied to a general computer in the form of a multi node board, multicore microcontroller, multicore microprocessor chips, SoCs, MCM, RISC and multicore coprocessor chips, that could be used in a smartphone, tablets, set-tops, workstations, a new form of HPC super computer, database and NoSQL appliance machine, genome machine, military device, robotics, Data Center in a box, entertainment center and super graphic CGI machine and even be used for gaming systems including combinations thereof. As Gigabyte fiber technology become more popular to the home eventually a type of Grid computing known as Star computing can allocate processing to the house set-top device that will be capable of consolidating the home workstation, gaming, home security and management, IoT devices, cable-box, smartphones, and entertainment devices into one unit or handheld gaming devices. Users will be able to have personal clouds that manage their personal files and cloud applications while being able to communicate through the cloud with others. Cloud applications will be able to index where users processing and files as located instead of storing everyone's data in a central repository. Cloud implementations of Star computing can allocate grid processing to personal clouds as if it were a virtualized data center. Having fiber technology brought into the home at Gigabit speed allows for processing that once was considered only practical in the Data Center and personal Adaptive Computing Machines can play a big part of the next phase of the cloud evolution.

The Adaptive Computing parallel-series Agentic AI Machine technology Agentic AI can be applied to cellphones, PDA devices, workstations, rack mounted units and even larger HPC computing systems. The present disclosure is not just another form of intelligent embedded application controller; rather it is a modular computing unit capable of benefitting from its arrangement in the system that can be applied to everything from gaming to robotics that not only can benefit from deep learning and AI but can utilize NLP and Agentic AI Agents to communicate with its surroundings and dynamically configure its controllers application compute kernels on the fly. In the instance of gaming imagine team sports like soccer or Foosball employing mini robot players that not only benefit from deep learning to accelerate their abilities but can now communicate with each other verbally, through Wi-Fi and Bluetooth networks and with servers be it in the cloud or locally for sophisticated live realistic actual play that is like watching the Pros play. In this case bystanders can be recognized by voice to give commands acting like coaches, not to mention the gambling aspects. Robotics have made huge strides from traditional AI and Deep Learning but now embedded Agentic AI in Adaptive Computing parallel-series is now on a whole new level. Cars that Autopilot is an advanced driver assistance systems can employ radar, visual, pressure and other sensors combined to learn how a driver habits can keep one safe, for instance some drivers don't like to be in packs since having tailgaters greatly increase the risk of an accident so the Adaptive Computing parallel-series Agentic AI Machine technology can be applied to adjust to the drivers actual driving style, habits and preferences and eventually after rigorous testing, and quality assurance including driver acceptance be put into production while driving and stored in local, edge, or cloud source control GitHub systems at various stages of the process. Industrial robotic machines can now benefit from Kaisen manufacturing and JIT (Just in Time) not to mention Discreet and Process MRP II by having the actual machines make suggestions to itself and the central Adaptive Computing parallel-series Agentic AI Machine technology that runs the plant or manufacturing cell to log the need for improvements from the robotic autonomous self-study through design analysis, performance, stress testing other forms of metadata to make improvements, generate the code and have the option of loading it after rigorous testing into the controllers of the robots compute devices.

Computer designs that employ Adaptable parallel-series cluster technologies today will eventually appear on the laptops, PDA and smartphones, IoT, Robotics, Industrial machines, Automotive, Gaming, Set-Tops, and wearables and even neural implants of tomorrow. Adaptable parallel-series Cluster technology that makes maximum use of sharing component and software resources in energy and cost effective manner can play a fundamental role in the everyday lifestyle of the future. Adaptive Computing Machines technology harnesses the available Agentic AI Autonomous Intelligence technology to enhance components that eventually will all work seamlessly lending itself so that its nodes or cores actually adapts its functionality dynamically while sharing resources effectively.

The low cost modular Adaptable parallel-series Agentic AI board drive has an internal bus connecter to a local Solid State Drive (SSD) in various configurations, which is where its operation system is but is not confine to. Its modular design permits almost any device that comprises the unit to be easily replaced. If a hard drive fails, it can be easily removed and a new Solid State Drive can be snapped into place. There are conventional miniaturized Solid State Drives and advanced Memristors type technologies that are now attached to regular sized motherboards that act like extended memory. This new design takes advantage of recent miniaturization of traditional motherboard technology by effectively attaching a motherboard to the physical footprint of a solid state drive. Thus, the modular solid state Adaptable parallel-series devices drive can appear to be almost the same shape and size as a regular conventional device with all the components of a board or set of boards comprising a device motherboard of any size accessible in one self-contained modular unit that is easy to repair and upgrade. This technology not only can be aimed at robotics, gaming, and cars but also in medical devices, wearables. IoT, Drones, civilian radar systems, home appliances, and almost any electronic device technology on the market.

Computer designs that employ Adaptable parallel-series cluster technologies today will eventually appear on the laptops, PDA and smartphones, IoT, Robotics, Industrial machines, Automotive, Gaming, Set-Tops, and wearables and even neural implants of tomorrow. Adaptable parallel-series Cluster technology that makes maximum use of sharing component and software resources in energy and cost effective manner can play a fundamental role in the everyday lifestyle of the future. Adaptive Computing Machines technology harnesses the available Agentic AI Autonomous Intelligence technology to enhance components that eventually will all work seamlessly lending itself so that its nodes or cores actually adapts its functionality dynamically while sharing resources effectively.

To be able to take advantage of not only the embedded virtual machine technology in the current processor chips, open source virtual machine software (like Xen, KVM (virtual machine open source . . . ) can be modified to recognize the Modular Adaptable parallel-series Agentic Ai device as a distinct unit and installed on a bare-metal or virtually assigned “master node” to allow easy set-up of rest of the machine. By having the option of employing a pliable or fixed cable fiber bus that allows flexible connections to be made, the Adaptable parallel-series DPU boards can be attached to a backplane primarily for physical support.

The present disclosure has been described mainly with respect to a printed circuit board embodiment. However, parts of the present disclosure can obviously be incorporated into a multi-function integrated circuit, thereby further reducing the footprint of the disclosed embodiments, and increasing the speed of response of the disclosure. Hopefully soon printed circuit board will employ fiber technology sandwiched between the layers of PCB boards as well as IC interconnect technologies. It is to be understood that the exemplary embodiments described herein are that for presently preferred embodiments and thus should be considered in a descriptive sense only and not for purposes of limitation. Descriptions of features or aspects within each embodiment should typically be considered as available for other similar features or aspects in other embodiments.

1. A computer system comprising:
a first node having an I/O controller hub including a main communication chipset;
a common bus; and
one or more adaptable parallel-series agentic artificial intelligence (AI) nodes coupled to said first node by said common bus, each of the one or more adaptable parallel-series agentic AI nodes comprising:
a memory operative to host an adaptable parallel-series operating system, and
at least one central processing unit (CPU) coupled to said memory, the respective one of the one or more adaptable parallel-series agentic AI nodes is configured without an adaptable parallel-series chipset,
wherein at least one of the one of more of adaptable agentic AI parallel-series nodes functions as a processing unit of the first node, and at least one of the one or more adaptable parallel-series agentic AI nodes is coupled to and shares the I/O controller hub.

2. The computer system of claim 1, wherein said I/O controller hub includes a main network device; and wherein at least one of the one or more adaptable parallel-series agentic AI nodes is coupled to and shares the main network device and is capable of dynamically generating code from multi-agent AI foundational models.

3. The computer system of claim 2, wherein at least one of the one or more adaptable parallel-series agentic AI nodes is directly coupled to and shares the main network device.

4. The computer system of claim 1, wherein the common bus physically and electrically connects one of the one or more adaptable parallel-series agentic AI nodes to another of the one or more adaptable parallel-series agentic AI nodes.

5. The computer system of claim 1, wherein the common bus couples the one or more adaptable parallel-series agentic AI nodes to the first node.

6. The computer system of claim 1, wherein each of the one or more adaptable parallel-series agentic AI nodes includes at least one solid state memory drive.

7. The computer system of claim 6, wherein each of the one or more adaptable parallel-series agentic AI nodes includes a solid-state drive (SSD).

8. The computer system of claim 1, wherein one of the one or more adaptable parallel-series agentic AI nodes hosts a first adaptable parallel-series operating system and another of the one or more adaptable parallel-series agentic AI nodes hosts a second adaptable parallel-series operating system that is different from said first adaptable parallel-series operating system.

9. The computer system of claim 1, wherein one of the one or more adaptable parallel-series agentic AI nodes and another of the one or more adaptable parallel-series agentic AI nodes host the same adaptable parallel-series operating system.

10. The computer system of claim 1, wherein one of the one or more adaptable parallel-series agentic AI nodes operates as a master node and another of the one or more adaptable parallel-series agentic AI nodes operates as a slave node.

11. The computer system of claim 1, wherein the common bus comprises at least one of a Peripheral Component Interconnect Express (PCIe) bus and a switched fiber fabric.

12. The computer system of claim 1, wherein the common bus serially connects one of the one or more adaptable parallel-series agentic AI nodes to another one of the one or more adaptable parallel-series agentic AI nodes.

13. The computer system of claim 1, wherein each of the one or more adaptable parallel-series agentic AI nodes comprises a first disk controller that is accessible by the common bus.

14. The computer system of claim 13, wherein each of the one or more adaptable parallel-series agentic AI nodes comprises a second disk controller configured to connect to an external storage device.

15. The computer system of claim 1, wherein the first node is absent a processing unit and operates as network HUB.

16. The computer system of claim 1, wherein the computer system is a virtualized computer system.

17. The computer system of claim 1, wherein a specific function is assigned to each of the one or more adaptable parallel-series agentic AI nodes, and upon request, the respective one of the one or more adaptable parallel-series agentic AI nodes executes the assigned specific function.

18. A computational device comprising:
a first node having an I/O controller hub;
a stack of one or more adaptable parallel-series devices, each of the adaptable parallel-series devices being coupled to the first node, each of the one or more adaptable parallel-series devices being operative to host an adaptable parallel-series operating system and each of the one or more adaptable parallel-series devices being connected to a memory; and
a common bus connecting the one or more adaptable parallel-series devices to the first node,
wherein at least one of the one or more of said adaptable parallel-series devices functions as a processing unit for the first node, and the at least one of the one or more adaptable parallel-series devices is coupled to and shares said I/O controller hub.

19. The computational device of claim 18, wherein the I/O controller hub comprises a main network device, and wherein at least one of the adaptable parallel-series devices is coupled to and shares the main network device.

20. The computational device of claim 19, wherein at least one of the adaptable parallel-series devices is coupled to and shares the main network device, and is absent an external I/O circuit.
